(19) United States
(12) Patent Application Publication
(10) Pub. No.: US 2024/0250727 A1
(43) Pub. Date: Jul. 25, 2024

(54) CSI FEEDBACK FOR MULTI-TRP URLLC SCHEMES

(71) Applicant: Telefonaktiebolaget LM Ericsson (publ), Stockholm (SE)

(72) Inventors: Siva Muruganathan, Stittsville (CA); Yufei Blankenship, Kildeer, IL (US); Jonas Fröberg Olsson, Ljungsbro (SE); Shiwei Gao, Nepean (CA); Bikramjit Singh, Raasepori (FI)

(21) Appl. No.: 18/017,769

(22) PCT Filed: Jul. 29, 2021
(86) PCT No.: PCT/IB2021/056938

§ 371 Date: Jan. 24, 2023

Related U.S. Application Data
(60) Provisional application No. 63/058,290, filed on Jul. 29, 2020.

(51) Int. Cl. H04B 7/06; H04B 7/204

(52) U.S. Cl. CPC H04B 7/0626; H04B 7/0632; H04B 7/0639; H04B 7/2043

(57) ABSTRACT

Systems and methods for Channel State Information (CSI) feedback for multi-TRP URLLC schemes are provided. In some embodiments, a method performed by a wireless device for CSI reporting includes: receiving a configuration for a plurality of Non-Zero Power (NZP) CSI-RS resources from a base station; performing channel measurement on the plurality of NZP CSI-RS resources; selecting N of the plurality of NZP CSI-RS resources; performing CSI computations and/or calculating CSI parameters including one or more of: one Rank Indicator (RI), N Precoding Matrix Indicators (PMIs), and one Channel Quality Indicator (CQI); and reporting the calculated CSI parameters. The parameters including one or more of: one RI, N PMIs, one CQI along with one or more of the following as part of CSI reporting: a single CSI-RS Resource Indicator (CRI) indicating the selected N NZP CSI-RS resources; N CRIs indicating the selected N NZP CSI-RS resources; and no CRI.

### RELATED APPLICATIONS

This application claims the benefit of provisional patent application Ser. No. 63/058,290, filed Jul. 29, 2020, the disclosure of which is hereby incorporated herein by reference in its entirety.

### TECHNICAL FIELD

The present disclosure relates to providing Channel State Information (CSI) feedback.

### BACKGROUND

New Radio (NR) uses CP-OFDM (Cyclic Prefix Orthogonal Frequency Division Multiplexing) in both downlink (DL) (i.e., from a network node, gNB, or base station, to a user equipment or UE) and uplink (UL) (i.e., from UE to gNB). Discrete Fourier Transform (DFT) spread Orthogonal Frequency Division Multiplexing (OFDM) is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain Physical Downlink Control Channel (PDCCH) and the rest contains physical shared data channel, either Physical Downlink Shared Channel (PDSCH) or Physical Uplink Shared Channel (PUSCH). Different subcarrier spacing values are supported in NR. The supported subcarrier spacing values (also referred to as different numerologies) are given by Δf=(15×2^{μ}) kHz where μ∈{0, 1, 2, 3, 4}. Δf=15 kHz is the basic subcarrier spacing. The slot durations at different subcarrier spacings are given by

$$\frac{1}{{2}^{μ}} ms .$$

In the frequency domain, a system bandwidth is divided into Resource Blocks (RBs); each corresponds to 12 contiguous subcarriers. The RBs are numbered starting with 0 from one end of the system bandwidth. The basic NR physical time-frequency resource grid is illustrated in FIG. 2, where only one RB within a 14-symbol slot is shown. One OFDM subcarrier during one OFDM symbol interval forms one Resource Element (RE).

Downlink transmissions can be dynamically scheduled, i.e., in each slot the gNB transmits Downlink Control Information (DCI) over PDCCH about which UE data is to be transmitted to and which RBs and OFDM symbols in the current downlink slot the data is transmitted on. PDCCH is typically transmitted in the first few OFDM symbols in each slot in NR. The UE data are carried on PDSCH.

There are three DCI formats defined for scheduling PDSCH in NR, i.e., DCI format 1_0, DCI format 1_1, and DCI format 1_2. DCI format 1_0 has a smaller size than DCI 1_1 and can be used when a UE is not connected to the network while DCI format 1_1 can be used for scheduling MIMO (Multiple-Input-Multiple-Output) transmissions with up to 2 transport blocks (TBs). DCI format 1_2 is introduced in NR Release 16 (Rel-16) to support configurable size for certain bit fields in the DCI.

One or more of the following bit fields may be included in a DCI
Frequency Domain Resource Assignment (FDRA)
Time Domain Resource Assignment (TDRA)
Modulation and Coding Scheme (MCS)
New Data Indicator (NDI)
Redundancy Version (RV)
Hybrid Automatic Repeat Request (HARQ) process number
PUCCH Resource Indicator (PRI)
PDSCH-to-HARQ_feedback timing indicator (K1)
Antenna port(s)
Transmission Configuration Indication (TCI)

### DL Channel State Information (CSI) Feedback

For DL CSI feedback, NR has adopted an implicit CSI mechanism where a UE feeds back the downlink channel state information including typically a transmission Rank Indicator (RI), a Precoder Matrix Indicator (PMI), and Channel Quality Indicator (CQI) for each codeword. The CQI/RI/PMI report can be either wideband or subband based on CSI report configuration.

The RI corresponds to a recommended number of layers that are to be spatially multiplexed and thus transmitted in parallel over the effective channel; the PMI identifies a recommended precoding matrix to use; the CQI represents a recommended modulation level (i.e., QPSK, 16QAM, etc.) and coding rate for each codeword or Transport Block (TB). NR supports transmission of one or two codewords to a UE in a slot. There is thus a relation between a CQI and a Signal to Interference plus Noise Ratio (SINR) of the spatial layers over which the codewords are transmitted.

### Channel State Information Reference Signals (CSI-RS)

For CSI measurement and feedback, CSI-RSs are defined. A CSI-RS is transmitted on each transmit antenna (or antenna port) and is used by a UE to measure downlink channel between each of the transmit antenna ports and each of its receive antennas. The antenna ports are also referred to as CSI-RS ports. The supported number of antenna ports in NR is {1, 2, 4, 8, 12, 16, 24, 32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

NZP CSI-RS can be configured to be transmitted in certain REs in a slot and certain slots. FIG. 3 shows an example of CSI-RS REs for 12 antenna ports, where 1 RE per RB per port is shown.

In addition, CSI Interference Measurement (CSI-IM) resource is also defined in NR for a UE to measure interference. A CSI-IM resource contains 4 REs, either 4 adjacent RE in frequency in the same OFDM symbol or 2 by 2 adjacent REs in both time and frequency in a slot. By measuring both the channel based on NZP CSI-RS and the interference based on CSI-IM, a UE can estimate the effective channel and noise plus interference to determine the CSI, i.e., rank, precoding matrix, and the channel quality.

### CSI Framework in NR

In NR, a UE can be configured with multiple CSI reporting settings (each represented by a higher layer parameter CSI-ReportConfig with an associated identity ReportConfigID) and multiple CSI resource settings (each represented by a higher layer parameter CSI-ResourceConfig with an associated identity CSI-ResourceConfigId). Each CSI resource setting can contain multiple CSI resource sets (each represented by a higher layer parameter NZP-CSI-RS-ResourceSet with an associated identity NZP-CSI-RS-ResourceSetId for channel measurement or by a higher layer parameter CSI-IM-ResourceSet with an associated identity CSI-IM-ResourceSetId for interference measurement), and each NZP CSI-RS resource set for channel measurement can contain up to 8 NZP CSI-RS resources. For each CSI reporting setting, a UE feeds back a set of CSIs, which may include one or more of a CRI (CSI-RS resource indicator), a RI, a PMI and a CQI per CW, depending on the configured report quantity.

Each Reporting Setting CSI-ReportConfig is associated with a single downlink Bandwidth Part (BWP) (indicated by higher layer parameter BWP-Id) given in the associated CSI-ResourceConfig for channel measurement and contains the parameter(s) for one CSI reporting band.
In each CSI reporting setting, it contains at least the following information:
   A CSI resource setting for channel measurement based on NZP CSI-RS resources (represented by a higher layer parameter resourcesForChannelMeasurement).
   A CSI resource setting for interference measurement based on CSI-IM resources (represented by a higher layer parameter csi-IM-ResourcesForInterference).
   Optionally, a CSI resource setting for interference measurement based on NZP CSI-RS resources (represented by a higher layer parameter nzp-CSI-RS-ResourcesForInterference).
   Time-domain behavior, i.e., periodic, semi-persistent, or aperiodic reporting (represented by a higher layer parameter reportConfigType).
   Frequency granularity, i.e., wideband or subband.
   CSI parameters to be reported such as RI, PMI, CQI, L1-RSRP/L1_SINR and CRI in case of multiple NZP CSI-RS resources in a resource set is used for channel measurement (represented by a higher layer parameter reportQuantity, such as ‘cri-RI-PMI-CQI’ ‘cri-RSRP’, or ‘ssb-Index-RSRP’).
   Codebook types, i.e., type I or II if reported, and codebook subset restriction.
   Measurement restriction.

For periodic and semi-static CSI reporting, only one NZP CSI-RS resource set can be configured for channel measurement and one CSI-IM resource set for interference measurement. For aperiodic CSI reporting, a CSI resource setting for channel measurement can contain more than one NZP CSI-RS resource set for channel measurement. If the CSI resource setting for channel measurement contains multiple NZP CSI-RS resource sets for aperiodic CSI report, only one NZP CSI-RS resource set can be selected and indicated to a UE. For aperiodic CSI reporting, a list of trigger states (given by the higher layer parameters CSI-AperiodicTriggerStateList) is configured. Each trigger state in CSI-AperiodicTriggerStateList contains a list of associated CSI-ReportConfigs indicating the Resource Set IDs for channel and optionally for interference. For a UE configured with the higher layer parameter CSI-AperiodicTriggerStateList, if a Resource Setting linked to a CSI-ReportConfig has multiple aperiodic resource sets, only one of the aperiodic CSI-RS resource sets from the Resource Setting is associated with the trigger state, and the UE is higher layer configured per trigger state per Resource Setting to select the one NZP CSI-RS resource set from the Resource Setting.

When more than one NZP CSI-RS resources are contained in the selected NZP CSI-RS resource set for channel measurement, a CSI-RS resource indicator (CRI) is reported by the UE to indicate to the gNB about the one selected NZP CSI-RS resource in the resource set, together with RI, PMI and CQI associated with the selected NZP CSI-RS resource. This type of CSI assumes that a PDSCH is transmitted from a single transmission point (TRP) and the CSI is also referred to as single TRP CSI. The following different reporting quantities are supported currently in NR for CSI feedback:
a single CRI, a single RI, a single PMI, and a single CQI, when higher layer parameter reportQuantity is set to cri-RI-PMI-CQI,
a single CRI, a single RI, and a wideband PMI (i1), when higher layer parameter reportQuantity is set to cri-RI-i1,
a single CRI, a single RI, a wideband PMI (i1), and a single CQI, when higher layer parameter reportQuantity is set to cri-RI-i1-CQI,
a single CRI, a single RI, and a single CQI, when higher layer parameter reportQuantity is set to cri-RI-CQI,
a single CRI, a single RI, a layer indicator (LI) which indicates which column of the precoder matrix of the reported PMI corresponds to the strongest layer, a PMI, and a CQI, when higher layer parameter reportQuantity is set to cri-RI-LI-PMI-CQI.

According to Third Generation Partnership Project (3GPP) TS 38.214, the UE calculates CSI parameters (if parameter(s) is reported) according to the following dependencies:
LI shall be calculated conditioned on the reported CQI, PMI, RI and CRI.
CQI shall be calculated conditioned on the reported PMI, RI and CRI.
PMI shall be calculated conditioned on the reported RI and CRI.
RI shall be calculated conditioned on the reported CRI.

### TCI States

Demodulation Reference Signals (DMRS) are used for coherent demodulation of PDSCH. The DMRS is confined to resource blocks carrying the associated PDSCH and is mapped on allocated Resource Elements (REs) of the OFDM time-frequency grid in NR such that the receiver can efficiently handle time/frequency-selective fading radio channels. A PDSCH can have one or multiple DMRS, each associated with an antenna port. The antenna ports used for PDSCH are indicated in DCI scheduling the PDSCH.

Several signals can be transmitted from different antenna ports in a same location. These signals can have the same large-scale properties, for instance in terms of Doppler shift/spread, average delay spread, or average delay, when measured at the receiver. These antenna ports are then said to be quasi co-located (QCL). The network can then signal to the UE that two antenna ports are QCL. If the UE knows that two antenna ports are QCL with respect to a certain parameter (e.g., Doppler spread), the UE can estimate that parameter based on a reference signal transmitted from one of the antenna ports and use that estimate when receiving another reference signal or physical channel the other antenna port. Typically, the first antenna port is represented by a measurement reference signal such as channel state information reference signal (CSI-RS) (known as a source RS) and the second antenna port is a DMRS (known as a target RS) for PDSCH reception.

In NR, a QCL relationship between a DMRS in PDSCH and other reference signals is described by a TCI state. A UE can be configured through Radio Resource Control (RRC) signaling with up to 128 TCI states in frequency range 2 (FR2) and up to 8 TCI states in FR1, depending on UE capability. Each TCI state contains QCL information, for the purpose of PDSCH reception. A UE can be dynamically signaled one or two TCI states in the TCI field in a DCI scheduling a PDSCH.

The supported QCL information types in NR are:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

UE assumptions for the purpose of deriving CQI/PMI/RI

In NR specification TS38.214 (Clause 5.2.2.5), the following UE assumptions are specified for the purpose of deriving CQI index, and if also configured, for deriving PMI and RI:
The first 2 OFDM symbols are occupied by control signaling.
The number of PDSCH and DM-RS symbols is equal to 12.
The same bandwidth part subcarrier spacing configured as for the PDSCH reception
The bandwidth as configured for the corresponding CQI report.
The reference resource uses the CP length and subcarrier spacing configured for PDSCH reception
No resource elements used by primary or secondary synchronization signals or PBCH.
Redundancy Version (RV) 0.
The ratio of PDSCH EPRE to CSI-RS EPRE is as given in Clause 5.2.2.3.1 of 3GPP TS 38.214.
Assume no REs allocated for NZP CSI-RS and ZP CSI-RS.
Assume the same number of front loaded DM-RS symbols as the maximum front-loaded symbols configured by the higher layer parameter maxLength in DMRS-DownlinkConfig.
Assume the same number of additional DM-RS symbols as the additional symbols configured by the higher layer parameter dmrs-AdditionalPosition.
Assume the PDSCH symbols are not containing DM-RS.
Assume Physical Resource Block (PRB) bundling size of 2 PRBS.

### PDSCH Transmission Over Multiple Transmission/Reception Points (TRP) or Panels

In one scenario, downlink data are transmitted over multiple TRPs in which different MIMO layers are transmitted over different TRPs. This is referred to a Non-coherent Joint Transmission (NC-JT). In another scenario, different time/frequency resources may be allocated to different TRPs and one or multiple PDSCH is transmitted over different TRPs. Two ways of scheduling multi-TRP transmission are specified in NR Rel-16: multi-PDCCH based multi-TRP transmission and single-PDCCH based multi-TRP transmission. The multi-PDCCH based multi-TRP transmission and single-PDCCH based multi-TRP transmission can be used to serve downlink eMBB traffic as well as downlink Ultra-Reliable and Low Latency Communication (URLLC) traffic to the UE.

### Single-PDCCH Based NC-JT or Scheme 1a

A PDSCH may be transmitted to a UE from multiple TRPs. Since different TRPs may be located in different physical locations and/or have different beams, the propagation channels can be different. To facilitate receiving PDSCH data from different TRPs or beams, a UE may be indicated with two TCI states, each associated with a TRP or a beam, by a single codepoint of a TCI field in a DCI.

One example of PDSCH transmission over two TRPs using a single DCI is shown in FIG. 4, where different layers of a PDSCH with a single codeword (e.g., CW0) are sent over two TRPs, each associated with a different TCI state. In this case, two DMRS ports, one for each layer, in two CDM groups are also signaled to the UE. A first TCI state is associated with the DMRS port in a first CDM group, and a second TCI state is associated with the DMRS port in a second CDM group. This approach is often referred to as NC-JT (Non-coherent joint transmission) or scheme 1a in NR Rel-16 3GPP discussions.

Transmitting PDSCH over multiple TRPs can also be used to improve PDSCH transmission reliability for URLLC applications. A number of approaches are introduced in NR Rel-16 including “FDMSchemeA”, “FDMSchemeB”, “TDMSchemeA” and Slot based Time Domain Multiplexing (TDM) scheme. Note that the terminology Scheme 4 is used in the (3GPP) discussions involving Slot based TDM scheme in NR Rel-16.

### FDMSchemeA and FDMSchemeB

An example of multi-TRP PDSCH transmission with FDMSchemeA is shown in FIG. 5, where a PDSCH is sent over TRP1 in PRGs (precoding RB groups) {0, 2, 4} and over TRP2 in PRGs {1, 3, 5}. The transmission from TRP1 is associated with TCI state 1, while the transmission from TRP2 is associated with TCI state 2. Since the transmissions from TRP1 and TRP2 are non-overlapping in the case of FDMSchemeA, the DMRS ports are the same (i.e., DMRS port 0 used for both transmissions). The PDSCH is scheduled by a PDCCH which is sent over TRP1.

FIG. 6 shows an example data transmission with FDMSchemeB in which PDSCH #1 is transmitted in PRGs {0, 2, 4} from TRP1 and PDSCH #2 with the same TB is transmitted in PRGs {1, 3, 5} from TRP2. The transmission from TRP1 is associated with TCI state 1, while the transmission from TRP2 is associated with TCI state 2. Since the transmissions from TRP1 and TRP2 are non-overlapping in the case of FDMSchemeB, the DMRS ports are the same (i.e., DMRS port 0 used for both transmissions). The two PDSCHs carry the same encoded data payload but with a same or different redundancy version so that the UE can do soft combining of the two PDSCHs to achieve more reliable reception.

In NR Rel-16, a UE can be configured by higher layer parameter RepSchemeEnabler to use one of the frequency domain multiplexing schemes ‘FDMSchemeA’ or ‘FDMSchemeB’. The UE can then be scheduled with one of these two schemes when the UE is indicated with two TCI states in a codepoint of the DCI field ‘Transmission Configuration Indication’ and DM-RS port(s) within one CDM group in the DCI field “Antenna Port(s)”. For ‘FDMSchemeA’ and ‘FDMSchemeB’, depending on the precoding granularity P′_{BWP,i} (which is given in terms of the number of consecutive resource blocks in the frequency domain), the PRBs assigned to TCI state 1 (i.e., TRP1) and TCI state 2 (i.e., TRP2) are given as follows:
If P′_{BWP,i} is determined as “wideband”, the first

$$⌈ \frac{{n}_{PRB}}{2} ⌉$$

PRBS are assigned to the first TCI state and the remaining

$$⌊ \frac{{n}_{PRB}}{2} ⌋$$

PRBS are assigned to the second TCI state, where n_{PRB} is the total number of allocated PRBs for the UE.
If P′_{BWP,i} is determined as one of the values among {2, 4}, even PRGs within the allocated frequency domain resources are assigned to the first TCI state and odd PRGs within the allocated frequency domain resources are assigned to the second TCI state.

### TDMSchemeA

FIG. 7 shows an example data transmission with TDMSchemeA in which PDSCH repetition occurs in mini-slots of four OFDM symbols within a slot. Each PDSCH can be associated with a same or different RV. The transmission of PDSCH #1 from TRP1 is associated with a first TCI state, while the transmission of PDSCH #2 from TRP2 is associated with a second TCI state.

In NR Rel-16, a UE can be configured by higher layer parameter RepSchemeEnabler to use ‘TDMSchemeA’ The UE can then be scheduled with ‘TDMSchemeA’ when the UE is indicated with two TCI states in a codepoint of the DCI field ‘Transmission Configuration Indication’ and DM-RS port(s) within one CDM group in the DCI field “Antenna Port(s)”. When the UE is scheduled with ‘TDMSchemeA’, the UE shall receive two PDSCH transmission occasions of the same TB with each TCI state associated to a PDSCH transmission occasion (i.e., the number of repetitions is limited to 2 in the case of ‘TDMSchemeA’). The two PDSCH transmission occasions have non-overlapping time domain resource allocation and both PDSCH transmission occasions shall be received within a given slot.

### Slot Based TDM Scheme or Scheme 4

An example Multi-TRP data transmission with Slot based TDM scheme is shown in FIG. 8, where four PDSCHs (i.e., PDSCH transmission occasions) for a same TB are transmitted over two TRPs and in four consecutive slots. Each PDSCH is associated with a different RV. The transmission of odd numbered PDSCHs from TRP1 are associated with a first TCI state, while the transmission of even numbered PDSCHs from TRP2 is associated with a second TCI state.

In fact, slot based TDM scheme is also applicable when PDSCH is transmitted from a single TRP with a single TCI state indicated in the scheduling DCI.

For scheduling PDSCH with slot based TDM scheme, at least one entry in pdsch-TimeDomainAllocationList information element in 3GPP TS 38.331 should be configured with repetitionNumber-r16 in PDSCH-TimeDomainResourceAllocation. The repetitionNumber-r16 is the number of repetitions involved in Scheme 4. Then, PDSCH with slot based TDM scheme can be scheduled to the UE, when the UE is indicated with the following:
one or two TCI states in a codepoint of the DCI field ‘Transmission Configuration Indication’
DCI field “Time domain resource assignment indicating an entry in pdsch-TimeDomainAllocationList which contain repetitionNumber-r16 in PDSCH-TimeDomainResourceAllocation, and
DM-RS port(s) within one CDM group in the DCI field “Antenna Port(s)”.

When two TCI states are indicated in a DCI with ‘Transmission Configuration Indication’ field, the UE may expect to receive multiple slot level PDSCH transmission occasions of the same TB with two TCI states (i.e., over 2 TRPs) used across multiple PDSCH transmission occasions in the repetitionNumber-r16 consecutive slots as defined in Clause 5.1.2.1 in 3GPP TS38.214.

When one TCI state is indicated in a DCI with ‘Transmission Configuration Indication’ field, the UE may expect to receive multiple slot level PDSCH transmission occasions of the same TB with one TCI state (i.e., over single TRP) used across multiple PDSCH transmission occasions in the repetitionNumber-r16 consecutive slots as defined in Clause 5.1.2.1 in 3GPP TS38.214.

In NR, repetitionNumber-r16 can be configured with values of 2, 3, 4, 5, 6, 7, 8, or 16.

For all the single-PDCCH based DL multi-TRP PDSCH schemes, a single DCI transmitted from one TRP is used to schedule multiple PDSCH transmissions over two TRPs. The network configures the UE with multiple TCI states via RRC, and a new MAC CE was introduced in NR Rel-16. This MAC CE can be used to map a codepoint in the TCI field to one or two TCI states.

LTE supports CSI feedback for NC-JT with two TRPs. For CSI feedback purpose in LTE, a UE is configured with a CSI process with two NZP CSI-RS resources, one for each TRP, and one interference measurement resource. Up to 8 antenna ports are possible in each NZP CSI-RS resource. The UE may report one of the following scenarios:
1. A UE reports CRI=0, which indicate that CSI is calculated and reported only for the first NZP CSI-RS resource, i.e., a RI, a PMI and a CQI associated with the first NZP CSI-RS resource is reported. This is the case when the UE sees best throughput is achieved by transmitting a PDSCH over the TRP or beam associated with the first NZP CSI-RS resource.
2. A UE reports CRI=1, which indicate that only CSI is calculated and reported for the second NZP CSI-RS resource, i.e., a RI, a PMI and a CQI associated with the second NZP CSI-RS resource is reported. This is the case when the UE sees best throughput is achieved by transmitting a PDSCH over the TRP or beam associated with the second NZP CSI-RS resource.
3. A UE reports CRI=2, which indicate both of the two NZP CSI-RS resources. In this case, two set of CSIs, each for one CW, are calculated and reported based on the two NZP CSI-RS resources and by considering inter-CW interference caused by the other CW. There are two RIs, two PMIs and two CQIs reported in this case. The combinations of reported RIs are restricted such that |RI1−RI2|<=1, where RI1 and RI2 respectively correspond to ranks associated with the 1^{st} and the 2^{nd} NXP CSI-RS respectively. Two CWs are transmitted in the case of LTE NC-JT as shown in FIG. 9.

In NR Rel-16, a different approach is adopted for NC-JT where a single CW is transmitted across two TRPs. An example is shown in FIG. 10, where one layer is transmitted from each of two TRPs. Hence, in the case of NC-JT CSI feedback two RIs, two PMIs, and a single CQI would need to be fed back for NR.

In some disclosures, CSI feedback for NC-JT is proposed. If two NZP CSI-RS resources are selected, two CRIs (one per selected NZP CSI-RS resource), two RIs (one per selected NZP CSI-RS resource), two PMIs (one per selected NZP CSI-RS resource), and a single CQI is reported as part of CSI. The CRI reported indicates the selected two NZP CSI-RS resources. Improved systems and methods for reporting CSI are needed.

### SUMMARY

Systems and methods for Channel State Information (CSI) feedback for Multiple Transmission/Reception Points (multi-TRP) Ultra-Reliable and Low Latency Communication (URLLC) schemes are provided. In some embodiments, a method performed by a wireless device for CSI reporting includes: receiving a configuration for a plurality of Non-Zero Power (NZP) CSI-RS resources from a base station; performing channel measurement on the plurality of NZP CSI-RS resources; selecting N of the plurality of NZP CSI-RS resources; performing CSI computations and/or calculating CSI parameters including one or more of: one Rank Indicator (RI), N Precoding Matrix Indicators (PMIs), and one Channel Quality Indicator (CQI); and reporting the calculated CSI parameters including one or more of: one RI, N PMIs, one CQI along with one or more of the following as part of CSI reporting: a single CSI-RS Resource Indicator (CRI) indicating the selected N NZP CSI-RS resources; N CRIs indicating the selected N NZP CSI-RS resources; and no CRI. With some embodiments of the current disclosure, more accurate CSI feedback for multi-TRP URLLC schemes can be reported from the wireless device to the base station which will result in improved spectral efficiency while maintaining transmission reliability.

In some embodiments of the current disclosure, solutions for reporting more accurate CSI for multi-TRP URLLC schemes are proposed. The solutions proposed include one or more of the following:
the User Equipment (UE) performing CSI computations and calculating CSI parameters including one RI, N PMI, and one CQI; this is followed by the UE reporting the calculated CSI parameters including one RI, N PMIs, one CQI along with one of the following as part of CSI reporting: a single CRI indicating the selected N NZP CSI-RS resources; N CRIs indicating the selected N NZP CSI-RS resources; and no CRI;
the UE taking into account one or more characteristics of the multi-TRP URLLC scheme for which CSI is computed. The characteristics that are taken into account include one or more of the following: the number of Physical Downlink Shared Channel (PDSCH) transmission occasions or repetitions; frequency domain PRB allocation; and the number of symbols per PDSCH transmission occasion/repetition.

In some embodiments, a method of CSI reporting from a UE to a New Radio Bas Station (gNB), includes one or more of: the UE receiving a configuration for a plurality of NZP CSI-RS resources from the gNB; the UE performing channel measurement on the plurality of NZP CSI-RS resources and selecting N of the plurality of NZP CSI-RS resources; the UE performing CSI computations and calculating CSI parameters including one RI, N PMI, and one CQI; the UE reporting the calculated CSI parameters including one RI, N PMIs, one CQI along with one of the following as part of CSI reporting: a single CSI-RS Resource Indicator (CRI) indicating the selected N NZP CSI-RS resources; N CRIs indicating the selected N NZP CSI-RS resources; no CRI.

In some embodiments, the plurality of NZP CSI-RS resources are configured as part of N NZP CSI-RS resource sets.

In some embodiments, a single CRI is used to select one NZP CSI-RS resource from each of the N NZP CSI-RS resource sets.

In some embodiments, the plurality of NZP CSI-RS resources is configured as part of a single NZP CSI-RS resource set.

In some embodiments, N CRIs are used to select N NZP CSI-RS resources from the single NZP CSI-RS resource set.

In some embodiments, the CSI parameters of one RI, N PMIs, one CQI along with one, N or no CRIs to be reported are configured by setting the reportQuantity field in CSI-ReportConfig information element to one of the following values: cri-RI-NPMI-CQI; Ncri-RI-NPMI-CQI; RI-NPMI-CQI.

In some embodiments, the UE takes into account one of a plurality of PDSCH transmission schemes for which CSI is computed.

In some embodiments, the PDSCH transmission scheme can be any one of FDMSchemeA, FDMSchemeB, TDMSchemeA, or SlotBasedTDM.

In some embodiments, the PDSCH transmission scheme for which to compute CSI is configures as part of the CSI-ReportConfig information element via a higher layer parameter reportingScheme.

In some embodiments, the UE assumes two repetitions when computing CSI when the PDSCH transmission scheme for which to compute CSI is either FDMSchemeB or TDMSchemeA.

In some embodiments, the UE assumes a single PDSCH transmission when computing CSI when the PDSCH transmission scheme for which to compute CSI is FDMSchemeA.

In some embodiments, the UE assumes P repetitions when computing CSI when the PDSCH transmission scheme for which to compute CSI is SlotBasedTDM. In some embodiments, P>1 is configured as part of CSI-ReportConfig. In some embodiments, P>1 is predefined in a specification.

In some embodiments, the CSI reference resource is defined by P consecutive slots with the last slot in downlink slot n−n_(CSI-ref) in time domain wherein the slot n_(CSI-ref) is predefined in specifications.

In some embodiments, the UE assumes a number of PDSCH symbols per repetition when computing CSI when the PDSCH transmission scheme for which to compute CSI is TDMSchemeA, wherein the number of PDSCH symbols per repetition is either predefined in specifications or is configured as part of CSI-ReportConfig. In some embodiments, the repetitions are PDSCH transmission occasions.

In some embodiments, the PRB bundling granularity to be assumed for CSI calculation by the UE is provided as part of CSI-ReportConfig or predefined in specifications when the PDSCH transmission scheme for which to compute CSI is either FDMSchemeA or FDMSchemeB.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example data scheduling in New Radio (NR) which in slot basis, shown with a 14-symbol slot;

FIG. 2 illustrates a basic NR physical time-frequency resource grid where only one Resource Block (RB) within a 14-symbol slot is shown;

FIG. 3 shows an example of Channel State Information Reference Signals (CSI-RS) Resource Elements (REs) for 12 antenna ports, where 1 RE per RB per port is shown;

FIG. 4 illustrates one example of Physical Downlink Shared Channel (PDSCH) transmission over two Transmission/Reception Points (TRPs) using a single Downlink Control Information (DCI);

FIG. 5 illustrates an example of multi-TRP PDSCH transmission with FDMSchemeA where a PDSCH is sent over TRP1 in PRGs (precoding RB groups) {0, 2, 4} and over TRP2 in PRGs {1, 3, 5};

FIG. 6 shows an example data transmission with FDMSchemeB in which PDSCH #1 is transmitted in PRGs {0, 2, 4} from TRP1 and PDSCH #2 with the same TB is transmitted in PRGs {1, 3, 5} from TRP2;

FIG. 7 shows an example data transmission with TDMSchemeA in which PDSCH repetition occurs in mini-slots of four Orthogonal Frequency Division Multiplexing (OFDM) symbols within a slot;

FIG. 8 illustrates an example Multi-TRP data transmission with Slot based Time Domain Multiplexing (TDM) scheme, where four PDSCHs for a same Transport Block (TB) are transmitted over two TRPs and in four consecutive slots;

FIG. 9 illustrates two Codewords (CWs) are transmitted in the case of Long Term Evolution (LTE) Non-coherent Joint Transmission (NC-JT);

FIG. 10 illustrates one layer is transmitted from each of two TRPs;

FIG. 11 illustrates one example of a cellular communications system in which embodiments of the present disclosure may be implemented;

FIG. 12 is a schematic block diagram of a radio access node according to some embodiments of the present disclosure;

FIG. 13 is a schematic block diagram that illustrates a virtualized embodiment of the radio access node according to some embodiments of the present disclosure;

FIG. 14 is a schematic block diagram of the radio access node according to some other embodiments of the present disclosure;

FIG. 15 is a schematic block diagram of a wireless communication device 1500 according to some embodiments of the present disclosure;

FIG. 16 is a schematic block diagram of the wireless communication device according to some other embodiments of the present disclosure;

FIG. 17 illustrates a communication system includes a telecommunication network, such as a Third Generation Partnership Project (3GPP)-type cellular network, which comprises an access network, such as a Radio Access Network (RAN), and a core network according to some other embodiments of the present disclosure;

FIG. 18 illustrates a communication system, a host computer comprises hardware including a communication interface configured to set up and maintain a wired or wireless connection with an interface of a different communication device of the communication system according to some other embodiments of the present disclosure; and

FIGS. 19 to 22 illustrate methods implemented in a communication system, according to some other embodiments of the present disclosure.

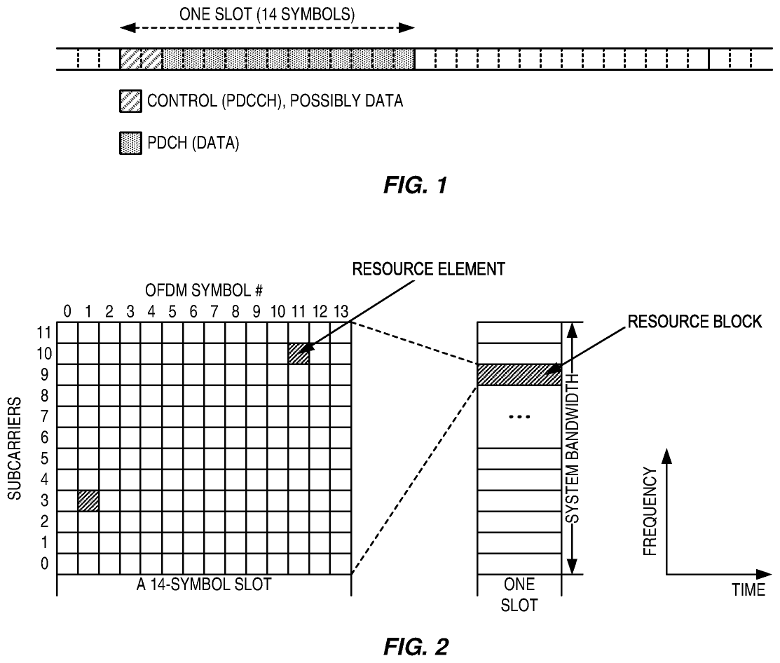

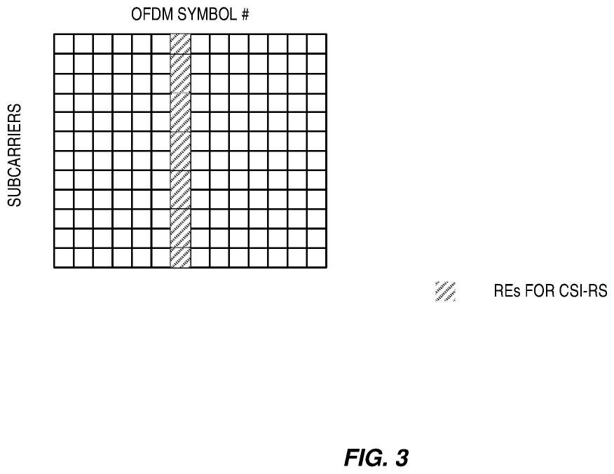

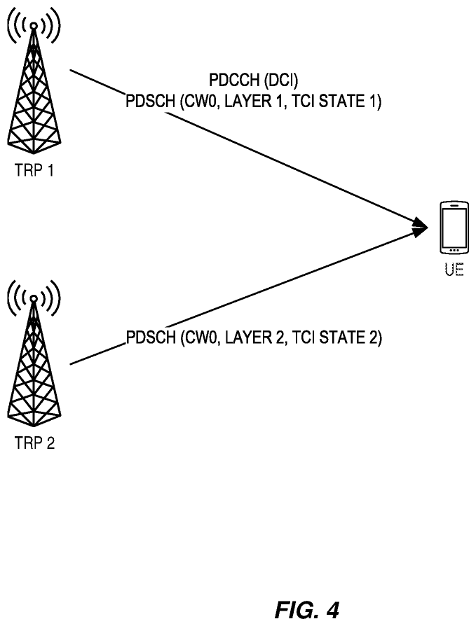

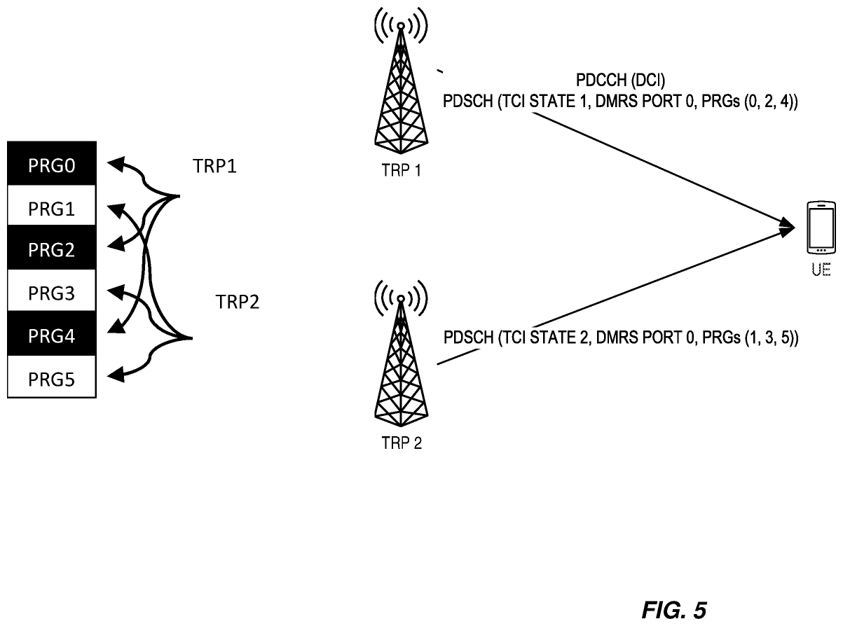

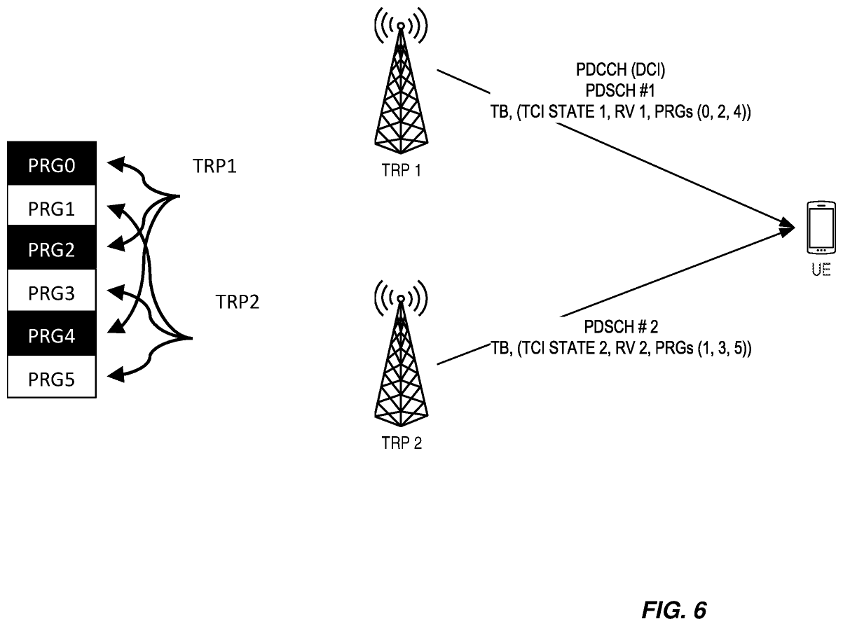

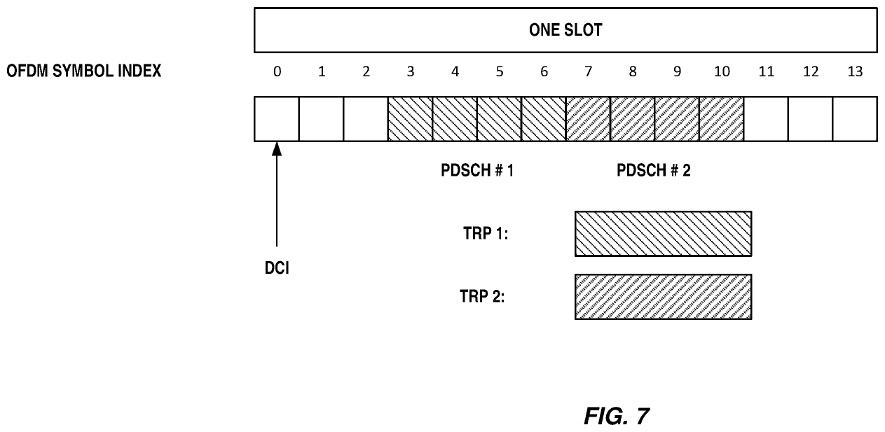

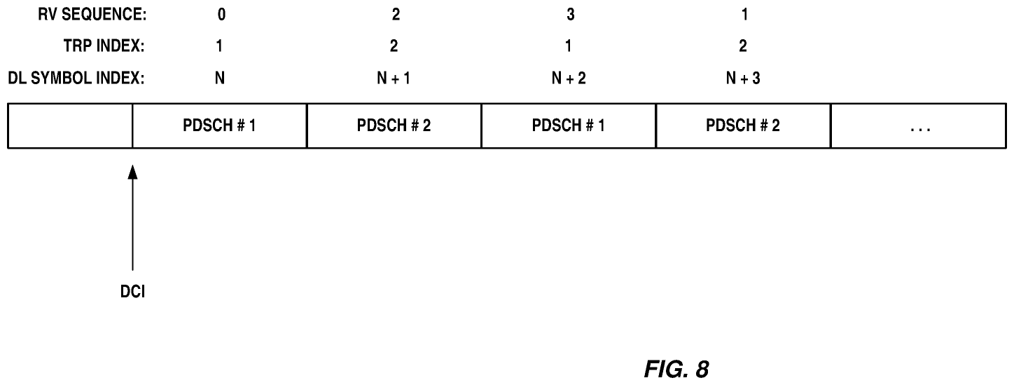

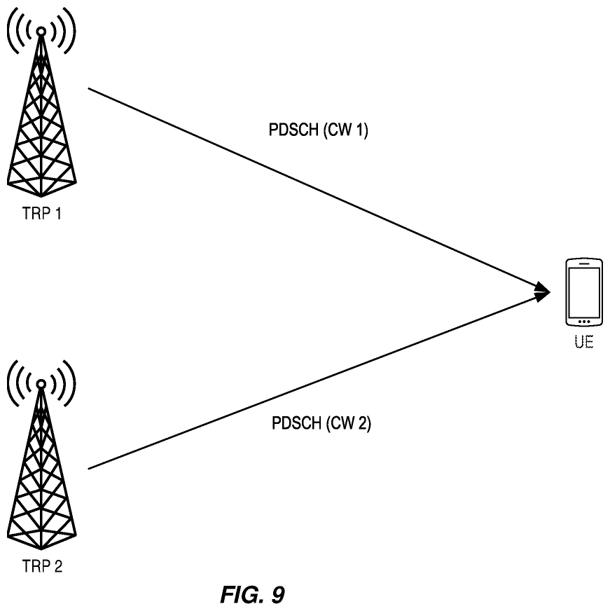

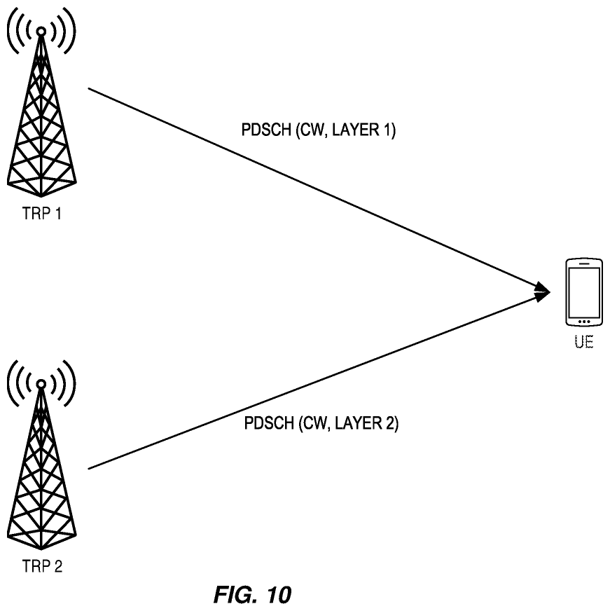

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

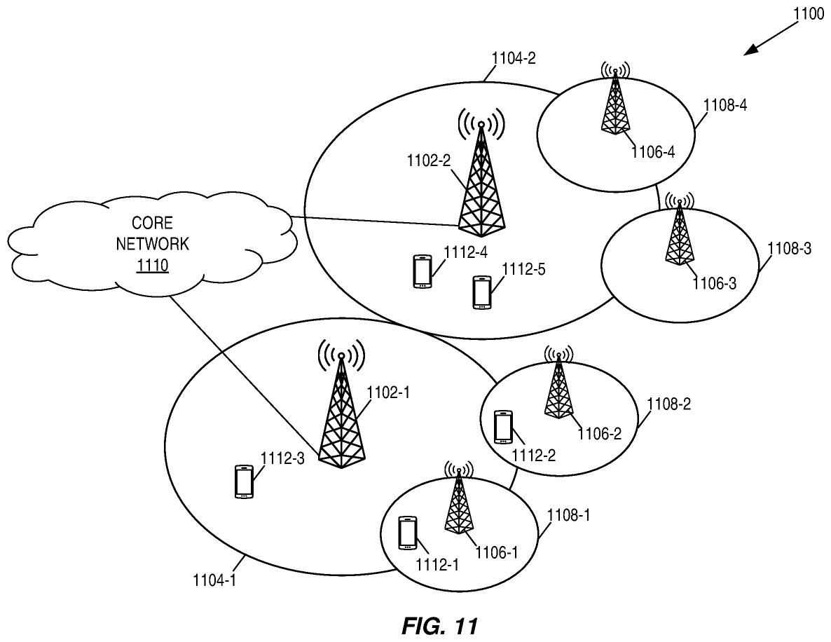

FIG. 11 illustrates one example of a cellular communications system 1100 in which embodiments of the present disclosure may be implemented. In the embodiments described herein, the cellular communications system 1100 is a 5G system (5GS) including a Next Generation RAN (NG-RAN) and a 5G Core (5GC). In this example, the RAN includes base stations 1102-1 and 1102-2, which in the 5GS include NR base stations (gNBs) and optionally next generation eNBs (ng-eNBs) (e.g., LTE RAN nodes connected to the 5GC), controlling corresponding (macro) cells 1104-1 and 1104-2. The base stations 1102-1 and 1102-2 are generally referred to herein collectively as base stations 1102 and individually as base station 1102. Likewise, the (macro) cells 1104-1 and 1104-2 are generally referred to herein collectively as (macro) cells 1104 and individually as (macro) cell 1104. The RAN may also include a number of low power nodes 1106-1 through 1106-4 controlling corresponding small cells 1108-1 through 1108-4. The low power nodes 1106-1 through 1106-4 can be small base stations (such as pico or femto base stations) or Remote Radio Heads (RRHs), or the like. Notably, while not illustrated, one or more of the small cells 1108-1 through 1108-4 may alternatively be provided by the base stations 1102. The low power nodes 1106-1 through 1106-4 are generally referred to herein collectively as low power nodes 1106 and individually as low power node 1106. Likewise, the small cells 1108-1 through 1108-4 are generally referred to herein collectively as small cells 1108 and individually as small cell 1108. The cellular communications system 1100 also includes a core network 1110, which in the 5G System (5GS) is referred to as the 5GC. The base stations 1102 (and optionally the low power nodes 1106) are connected to the core network 1110.

The base stations 1102 and the low power nodes 1106 provide service to wireless communication devices 1112-1 through 1112-5 in the corresponding cells 1104 and 1108. The wireless communication devices 1112-1 through 1112-5 are generally referred to herein collectively as wireless communication devices 1112 and individually as wireless communication device 1112. In the following description, the wireless communication devices 1112 are oftentimes UEs, but the present disclosure is not limited thereto.

The previous solutions described above only address Channel State Information (CSI) feedback for Non-coherent Joint Transmission (NC-JT). CSI feedback optimized for Multiple Transmission/Reception Point (multi-TRP) Ultra-Reliable and Low Latency Communication (URLLC) schemes such as FDMSchemeA, FDMSchemeB, TDMSchemeA, and Slot based Time Domain Multiplexing (TDM) scheme (scheme 4) are not known currently. Hence, it is an open problem of how to optimize CSI reporting for multi-TRP URLLC schemes.

Systems and methods for CSI feedback for multi-TRP URLLC schemes are provided. In some embodiments, a method performed by a wireless device for CSI reporting includes: receiving a configuration for a plurality of Non-Zero Power (NZP) Channel State Information Reference Signal (CSI-RS) resources from a base station; performing channel measurement on the plurality of NZP CSI-RS resources; selecting N of the plurality of NZP CSI-RS resources; performing CSI computations and/or calculating CSI parameters including one or more of: one Rank Indicator (RI), N Precoding Matrix Indicators (PMIs), and one Channel Quality Indicator (CQI); and reporting the calculated CSI parameters including one or more of: one RI, N PMIs, one CQI along with one or more of the following as part of CSI reporting: a single CSI-RS Resource Indicator (CRI) indicating the selected N NZP CSI-RS resources; N CRIS indicating the selected N NZP CSI-RS resources; and no CRI. With some embodiments of the current disclosure, more accurate CSI feedback for multi-TRP URLLC schemes can be reported from the wireless device to the base station which will result in improved spectral efficiency while maintaining transmission reliability.

In the case of multi-TRP schemes, different NZP CSI-RSs will be transmitted from different TRPs (i.e., associated with different Transmission Configuration Indicator (TCI) states) on which the UE performs channel measurements. There are multiple ways to configure the different NZP CSI-RS resources as given below:
Case 1: the NZP CSI-RSs transmitted from each TRP are configured inside an NZP-CSI-RS-ResourceSet. Hence, the multiple NZP-CSI-RS-ResourceSets within the CSI-ResourceConfig configured in a CSI-ReportConfig via the parameter resourcesForChannelMeasurement. Each NZP-CSI-RS-ResourceSet may consist of one or more NZP CSI-RS resources. When the NZP-CSI-RS-ResourceSet consists of multiple NZP CSI-RS resources particularly in FR2, each of the NZP CSI-RS resources is associated with a different TCI state (i.e., different beam or different QCL-Type D RS).
Case 2: the NZP CSI-RSs transmitted from different TRPs are configured within a single NZP-CSI-RS-ResourceSet. Hence, a single NZP-CSI-RS-ResourceSet within the CSI-ResourceConfig may be sufficient in this case. In this case, each NZP-CSI-RS-ResourceSet consists of multiple NZP CSI-RS resources where each of the NZP CSI-RS resources is associated with a different TCI state.

To support CSI feedback for multi-TRP URLLC schemes, channel measurements have to be performed over at least 2 NZP CSI-RS resources (i.e., at least 2 TRPs). In one embodiment, assuming Case 1 above, the UE may report a single CRI value where the CRI value indicates the NZP CSI-RS resource chosen by the UE to be fed back as part of the CSI report. The single CRI value can be an index to the NZP CSI-RS resource chosen from each of the M NZP-CSI-RS-ResourceSets configured for channel measurement in a CSI-ReportConfig. For instance, when two (M=2) NZP-CSI-RS-ResourceSets are configured for channel measurement in a CSI-ReportConfig, a CRI value j may indicate the j^{th} NZP CSI-RS resource chosen from the two NZP-CSI-RS-ResourceSets. In some embodiments for Case 1, if each of the NZP-CSI-RS-ResourceSets configured for channel measurement in a CSI-ReportConfig consists of a single NZP CSI-RS resource, then the CRI may not be reported as part of the CSI feedback. In some other embodiments for Case 1, multiple CRI indices may be reported by the UE. For instance, when two (M=2) NZP-CSI-RS-ResourceSets are configured for channel measurement in a CSI-ReportConfig, a first CRI (CRI1) value j may indicate the j^{th} NZP CSI-RS resource chosen from the first NZP-CSI-RS-ResourceSet and a second CRI (CRI2) value k may indicate the kth NZP CSI-RS resource chosen from the second NZP-CSI-RS-ResourceSet.

For Case 2 above, in one embodiment, the UE may report multiple CRI values where each CRI value indicates one of the NZP CSI-RS resources chosen from the NZP-CSI-RS-ResourceSet. For instance, when NNZP CSI-RS resources are configured in the NZP-CSI-RS-ResourceSet configured for channel measurement in a CSI-ReportConfig, a first CRI (CRI1) value j may indicates the j^{th} NZP CSI-RS resource chosen from the NZP-CSI-RS-ResourceSet and a second CRI (CRI2) value k may indicate the kth NZP CSI-RS resource chosen from the NZP-CSI-RS-ResourceSet. In some embodiments, CRIs may not be reported when the NZP-CSI-RS-ResourceSet only contains the same number of NZP CSI-RS resources that are to be selected. For instance, when NZP-CSI-RS-ResourceSet only contains the two NZP CSI-RS resources and the UE is to use these two NZP CSI-RS resources for channel measurement, then there is no need to include the CRIs as part of the CSI report.

Once the NZP CSI-RS resources are chosen (which may be reported via CRI), the UE selects the RI. It should be noted that in the case of all the multi-TRP URLLC schemes (i.e., FDMSchemeA, FDMSchemeB, TDMSchemeA, and Slot based TDM scheme); a single RI needs to be jointly determined over the chosen NZP CSI-RS resources. This is because in the case of multi-TRP URLLC schemes, the same number of DMRS ports is transmitted in the non-overlapping time/frequency resources corresponding to the two TCI states (i.e., two TRPs). Hence, as part of the CSI feedback, it is sufficient to feedback a single RI value for all the multi-TRP URLLC schemes. This is different from the case of CSI feedback for NC-JT based multi-TRP transmission in which case multiple RIs are fed back as part of the CSI feedback (i.e., one RI per NZP CSI-RS resource selected).

Once the CRI (if reported) and RI are chosen, UE also feeds back multiple PMIs (one per selected NZP CSI-RS resource) and a single CQI as part of CSI for multi-TRP URLLC schemes.

Hence, assuming the case of two TRPs corresponding to two TCI states, one of the following values may be configured for reportQuantity as part of the CSI-ReportConfig information element:
‘cri-RI-2PMI-CQI’ which corresponds to single CRI, single RI, two PMIs, and a single CQI as part of the CSI report,
‘2cri-RI-2PMI-CQI’ which corresponds to two CRIs, single RI, two PMIs, and a single CQI as part of the CSI report. In this case, 2 CSI-RS resources are selected from a CSI-RS resource set containing more than 2 CSI-RS resources or from two CSI-RS resource sets by the UE
‘RI-2PMI-CQI’ which corresponds to single RI, two PMIs, and a single CQI as part of the CSI report. In this case, either 2 CSI-RS resources are contained in a single CSI-RS resource set or in two CSI-RS resource sets each containing one CSI-RS resource.

In the following, it is illustrated how the above reporting options are provided as configuration options:

| CSI-ReportConfig ::= | SEQUENCE { |
|---|---|
| ... | |
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED |
| {n2, n4}OPTIONAL -- Need S | |
| }, | |
| cri-RI-CQI | NULL, |
| cri-RSRP | NULL, |
| ssb-Index-RSRP | NULL, |
| cri-RI-LI-PMI-CQI | NULL, |
| cri-RI-2PMI-CQI | NULL, |
| 2cri-RI-2PMI-CQI | NULL, |
| RI-2PMI-CQI | NULL |

...
},

It is noted that for a UE capable of operating with multi-TRP, two (or more) CSI reports can be configured, with one CSI report configured to report for single-TRP operation, and another CSI report configured to report for multi-TRP operation, where the multi-TRP operation is identified by the reportQuantity being set a value associated with one of the multi-TRP URLLC schemes (for example, ‘cri-RI-2PMI-CQI’ or ‘2cri-RI-2PMI-CQI’ or ‘RI-2PMI-CQI’).

If the reportQuantity is ‘cri-RI-2PMI-CQI’, then the UE calculates CSI parameters according to the following dependencies:
CQI shall be calculated conditioned on the reported multiple (e.g., 2) PMIs, RI and CRI.
The multiple (e.g., 2) PMIs shall be calculated conditioned on the reported RI and CRI.
RI shall be calculated conditioned on the reported CRI.

If the reportQuantity is ‘2cri-RI-2PMI-CQI’, then the UE calculates CSI parameters according to the following dependencies:
CQI shall be calculated conditioned on the reported multiple (e.g., 2) PMIs, RI and multiple (e.g., 2) CRIs.
The multiple (e.g., 2) PMIs shall be calculated conditioned on the reported RI and multiple (e.g., 2) CRIs.
RI shall be calculated conditioned on the reported multiple (e.g., 2) CRIs.

If the reportQuantity is ‘RI-2PMI-CQI’, then the UE calculates CSI parameters according to the following dependencies:
CQI shall be calculated conditioned on the reported multiple (e.g., 2) PMIs and RI
the multiple (e.g., 2) PMIs shall be calculated conditioned on the reported RI

For interference measurement, a single Channel State Information Interference Measurement (CSI-IM) resource set with one or more CSI-IM resources may be associated with the CSI report.

In one embodiment, when a transmission in the multi-TRP URLLC scheme using TRPs in a set, say {TRP1, TRP2}, is performed from TRP1 the interference is different from if transmission is from TRP2. This is due to that there may be other set of TRPs performing multi-TRP transmission scheme according to Frequency Domain Multiplexing (FDM) or TDM. In such embodiments, it is preferred that CSI-IM resources are paired with the CSI-RS. The CSI-IM resources may be configured in a CSI-IM-ResourceSet and UE may be configured with “paired CSI-RS and CSI-IM” parameter indicating that for each NZP CSI-RS resource to be used for channel measurement in the NZP-CSI-RS-ResourceSet there is a corresponding CSI-IM resource to be used for interference measurement in CSI-IM-ResourceSet.

In some embodiments, the CSI reported may be impacted by the order in which two NZP CSI-RS resources with different TCI states (i.e., corresponding to different TRPs) are measured. For instance, consider NZP CSI-RS resource #1 from TRP #1 and NZP CSI-RS resource #2 from TRP #2. Depending on the order in which NZP CSI-RS resources are measured, then for different Multi-TRP URLLC schemes (e.g., FDMSchemeA, FDMSchemeB, TDMSchemeA, or SlotBasedTDM), the UE will assume different time/frequency resources when computing PMIs corresponding to the different NZP CSI-RS resources. Hence, in some embodiments, the UE may indicate the order via the CRIs. For instance, the UE may compute CSI assuming the both the orders (NZP CSI-RS resource #1, NZP CSI-RS resource #2) and (NZP CSI-RS resource #2, NZP CSI-RS resource #1), and indicate the order that yields the best CQI as part of the CSI report. In another embodiment, the order may be indicated explicitly (via an order index) in the CSI report.

The CSI report can be either periodic, semi-persistent or aperiodic. In case of aperiodic CSI report, the one or two CSI-RS resource sets and the one CSI-IM resource set can be configured in the corresponding aperiodic CSI trigger state.

### CSI Reporting Configuration for Specific Multi-TRP URLLC Schemes

The different URLLC multi-TRP schemes differ in the following characteristics for the purpose of improving reliability:
The number of Physical Downlink Shared Channel (PDSCH) transmission occasions or repetitions: FDMSchemeA involves only a single PDSCH transmission occasion; FDMSchemeB and TDMSchemeA involve two transmission occasions/repetitions of the same TB with different Redundancy Versions (RVs); the Slot based TDM scheme (scheme 4) may involve up to 16 repetitions of the same TB.
Frequency domain PRB allocation: for FDMSchemeA and FDMSchemeB the PRB allocation depends on precoding granularity P′_{BWP,i} which can be ‘wideband’, ‘2 PRBs’, or ‘4 PRBs.’
TDMSchemeA involves two PDSCH transmission occasions/repetitions within a slot with equal number of symbols per PDSCH transmission occasion/repetition.

However, these characteristics are currently not taken into account when computing CQI, PMI, and RI. As discussed above in Section 2.1.6, the currently specified UE assumption for deriving CQI/PMI/RI involves the following:
Assume single PDSCH transmission occasion with RV0
Assume PRB bundling size of 2 PRBs
Assume 12 symbols for PDSCH and DM-RS per slot

Hence, due to the mismatch between the PDSCH transmission characteristics of the different URLLC multi-TRP schemes and what is currently assumed by an NR UE for CSI feedback, the currently reported NR CSI feedback will be inaccurate.

Hence, in one embodiment, the specific Multi-TRP URLLC scheme for which CSI feedback is desired is configured as part of the CSI-ReportConfig. For example, as shown below in the example CSI-ReportConfig information element, a reportingScheme parameter may be configured in the CSI-ReportConfig information element in 3GPP TS 38.331 which signals to the UE a specific Multi-TRP URLLC scheme for which to provide CSI. Using the indicated Multi-TRP URLLC scheme, the UE can perform more accurate CSI estimation using number of PDSCH transmission occasions/repetitions, the precoding granularity, and/or the number of PDSCH symbols as used in the specific Multi-TRP URLLC scheme.

### CSI-ReportConfig Information Element

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R
...

| | |
|---|---|
| reportingScheme | ENUMERATED {FDMSchemeA, |

FDMSchemeB, TDMSchemeA, SlotBasedTDM} OPTIONAL -- Need S

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED |

{n2, n4} OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},
...
-- TAG-CSI-REPORTCONFIG-STOP
-- ASN1STOP

An example of configuring the Multi-TRP URLLC scheme in the CSI-ReportConfig.

If reportingScheme is configured to FDMSchemeB or TDMSchemeA, the UE may assume two repetitions when computing CSI. In some cases, the RV values to be used for these two repetitions may be predefined in 3GPP specifications, for example, RV=0 for both PDSCH transmission occasions, or may be configured to the UE as part of the CSI-ReportConfig.

If reportingScheme is configured to FDMSchemeA, the UE assumes a single PDSCH transmission occasion when computing CSI.

If reportingScheme is configured to SlotBasedTDM, the number of repetitions to use when computing CSI can be either predefined in 3GPP specifications, for example, 2 repetitions, or may be configured to the UE as part of the CSI-ReportConfig. In some cases, the RV values to be used for the predefined/configured repetitions may be predefined in 3GPP specifications, for example with RV=0 for all PDSCH transmission occasions or may be configured to the UE as part of the CSI-ReportConfig. In some cases, an RV pattern may be configured to the UE.

If reportingScheme is configured to FDMSchemeA or FDMSchemeB, then the precoder bundle size to use for the purpose of CSI computation may be configured as part of the CSI-ReportConfig. The precoder bundle size may take on values of ‘wideband’, ‘2 PRBs’ or ‘4 PRBs’. If precoder bundle size is wideband, then the PMI corresponding to the 1^{st} selected NZP CSI-RS resource (corresponding to the 1^{st} TRP or 1^{st} TCI state) is used on the first half of the PRBs over which CSI is computed. Similarly, the PMI corresponding to the 2^{nd} selected NZP CSI-RS resource (corresponding to the 2^{nd} TRP or 2^{nd} TCI state) is used on the second half of the PRBs over which CSI is computed. If precoder bundle size of either 2 or 4 PRBs is configured, then the PMIs corresponding to the 1^{st} and the 2^{nd} selected NZP CSI-RS resources will be interleaved according to the configured PRB bundling size.

If reportingScheme is configured to TDMSchemeA, the number of symbols per PDSCH transmission occasion/repetition to use when computing CSI can be either predefined in 3GPP specifications or may be configured to the UE as part of the CSI-ReportConfig.

For FDMSchemeA and FDMSchemeB, the group of downlink physical resource blocks are associated with the two CSI-RS resources according to the configured PRB bundling granularity (or PRG size) for the CSI as follows:
For “wideband” granularity, the first [n_{PRB}/2] PRBs are associated to the CSI-RS resource and the remaining [n_{PRB}/2] PRBs are associated to the second CSI-RS resource, where n_{PRB} is the total number of PRBs in the band to which the derived CSI relates, where association of RBs to a CSI-RS resource means that the PDSCH in the RBs goes through the same channel as the CSI-RS.
For granularity of one of the values among {2, 4}, even PRGs within the band are associated to the first CSI-RS resource and odd PRGs within the allocated frequency domain resources are associated to the second CSI-RS resource. Similar method applied if other granularity values are defined.

In some other embodiments, the signaling of the Multi-TRP URLLC scheme can be implicitly indicated via one or more of the following parameters which may be configured to the UE:
Number of repetitions to be assumed during CSI calculation.
RV values to be assumed during CSI calculation.
The precoder bundle size to be assumed during CSI calculation.
The number of symbols per PDSCH transmission occasion/repetition to be assumed during CSI calculation.

For instance, if the number of repetitions is configured to be one and the precoder bundle size is configured, then this implies FDMSchemeA.

If the number of repetitions is configured to be two and the precoder bundle size is configured, then this implies FDMSchemeB.

If the number of repetitions is configured to be two, the precoder bundle size is not configured, and the number of symbols per PDSCH transmission occasion/repetition is configured, then this implies TDMSchemeA.

If the number of repetitions is configured to be larger than two, then this implies SlotBasedTDM.

Although the above only lists a few examples of implicitly indicating the multi-TRP URLLC scheme to assume for CSI computation, these examples are non-limiting. Other combinations of parameters configured in CSI-ReportingConfig can be used to define the implicit signaling of the multi-TRP URLLC scheme.

It is noted that the support of multi-TRP URLLC scheme is a type of UE capability, which UE signals to the gNB in the beginning of connection. Hence the gNB signals the appropriate multi-TRP scheme for data communication, and appropriate scheme for CSI reporting, taking into consideration of reported UE capability, operating frequency (e.g., FR1 vs FR2), performance requirement of the traffic, etc.

### CSI Reference Resource for Multi-TRP URLLC Schemes

In NR, a CQI reported by a UE in uplink slot n′ is derived based on an unrestricted or restricted observation interval in time, and an unrestricted observation interval in frequency and is the highest CQI index in a CQI table which satisfies the following condition:
A single PDSCH transport block with a combination of modulation scheme, target code rate and transport block size corresponding to the CQI index, and occupying a group of downlink physical resource blocks termed the CSI reference resource, could be received with a transport block error probability (P_{BLER}) not exceeding a threshold associated with the CQI table

The CSI reference resource for a serving cell is defined by (a) the group of downlink physical resource blocks corresponding to the band to which the derived CSI relates in frequency domain, and (b) a single downlink slot n−n_{CSI-ref} in time domain, where

$$n = ⌊ {n}^{′} \cdot \frac{{2}^{μ} DL}{{2}^{μ} UL} ⌋$$

and μ_{DL} and μ_{UL} are the subcarrier spacing configurations for DL and UL, respectively.

For SlotBasedTDM URLLC scheme, since a PDSCH is repeated in multiple consecutive slots, more than one DL slot is required for the CSI reference resource. Therefore, for P repetitions configured for a CSI report, the CSI reference resource is defined by P consecutive downlink slots with the last downlink slot in n−n_{CSI-ref} in time domain.

### High Density CSI-RS and CSI-IM

For CSI reporting associated very low Block Error Rate (BLER), high CSI measurement accuracy is needed. One way to achieve it is to have more channel and/or noise and interference samples. In existing CSI resource in NR, either one sample per Resource Block (RB) or one sample every two RBs for each CSI-RS port can be configured for a CSI-RS resource with 2 or more CSI-RS ports. To improve channel measurement accuracy, high density CSI-RS resource may be introduced in which more than one sample per RB per CSI-RS port can be configured for CSI-RS with 2 or more CSI-RS ports. For example, 2 or 4 samples per RB per CSI-RS port. This can be achieved by either CSI-RS repetition in frequency, in time, or defining new CSI-RS patterns.

Similarly, high density CSI-IM may be introduced to improve noise and interference measurement accuracy. Currently in NR, only 4 ports CSI-IM can be configured. To improve measurement accuracy, CSI-IM with more than 4 ports can be used. Again, this can be achieved by either CSI-IM repetition in frequency, in time, or defining new CSI-IM patterns.

### Resource Set for CSI-RS

For CSI reporting for extremely low latency or URLLC transmissions, the resource grid can be configured with for instance periodic CSI-RS (with certain periodicity). From these CSI-RS, UE estimates channel parameters, e.g., CQI, PMI etc. In one non-limiting proposal, multiple periodicities can be defined from extremely dense to extremely sparse periodicities. When gNB receives CSI estimates from the UE and gNB compares with last estimates or a window of estimates, based on that gNB can request UE to switch to denser or sparser periodicity. For instance, if gNB notices deviation more than threshold high in the reporting, gNB can request UE to switch to denser CSI-RS configuration. If gNB does not notice deviation lower than a threshold low, gNB can request to switch to lower periodicity. Instead of increasing or decreasing periodicities, gNB can enable increasing or decreasing number of samples per RB for the CSI-RS port. Similar technique can be replicated for CSI-IM.

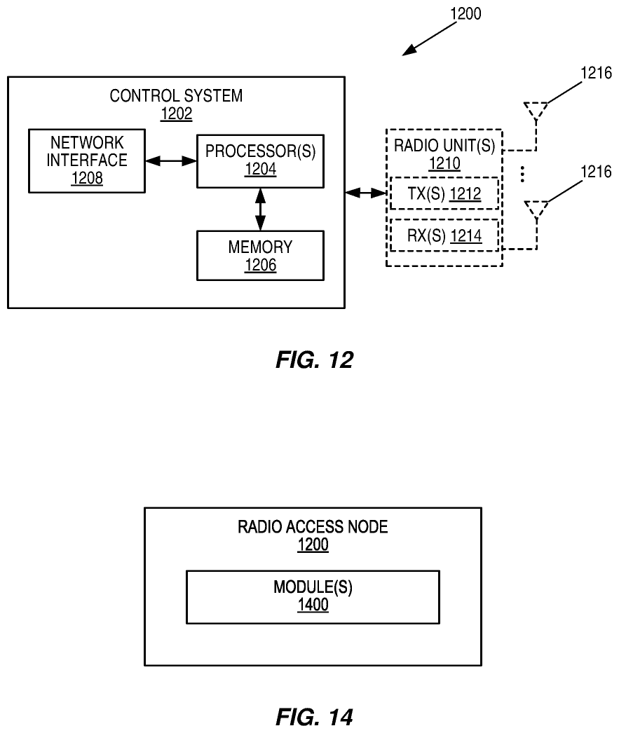

FIG. 12 is a schematic block diagram of a radio access node 1200 according to some embodiments of the present disclosure. Optional features are represented by dashed boxes. The radio access node 1200 may be, for example, a base station 1102 or 1106 or a network node that implements all or part of the functionality of the base station 1102 or gNB described herein. As illustrated, the radio access node 1200 includes a control system 1202 that includes one or more processors 1204 (e.g., Central Processing Units (CPUs), Application Specific Integrated Circuits (ASICs), Field Programmable Gate Arrays (FPGAs), and/or the like), memory 1206, and a network interface 1208. The one or more processors 1204 are also referred to herein as processing circuitry. In addition, the radio access node 1200 may include one or more radio units 1210 that each includes one or more transmitters 1212 and one or more receivers 1214 coupled to one or more antennas 1216. The radio units 1210 may be referred to or be part of radio interface circuitry. In some embodiments, the radio unit(s) 1210 is external to the control system 1202 and connected to the control system 1202 via, e.g., a wired connection (e.g., an optical cable). However, in some other embodiments, the radio unit(s) 1210 and potentially the antenna(s) 1216 are integrated together with the control system 1202. The one or more processors 1204 operate to provide one or more functions of a radio access node 1200 as described herein. In some embodiments, the function(s) are implemented in software that is stored, e.g., in the memory 1206 and executed by the one or more processors 1204.

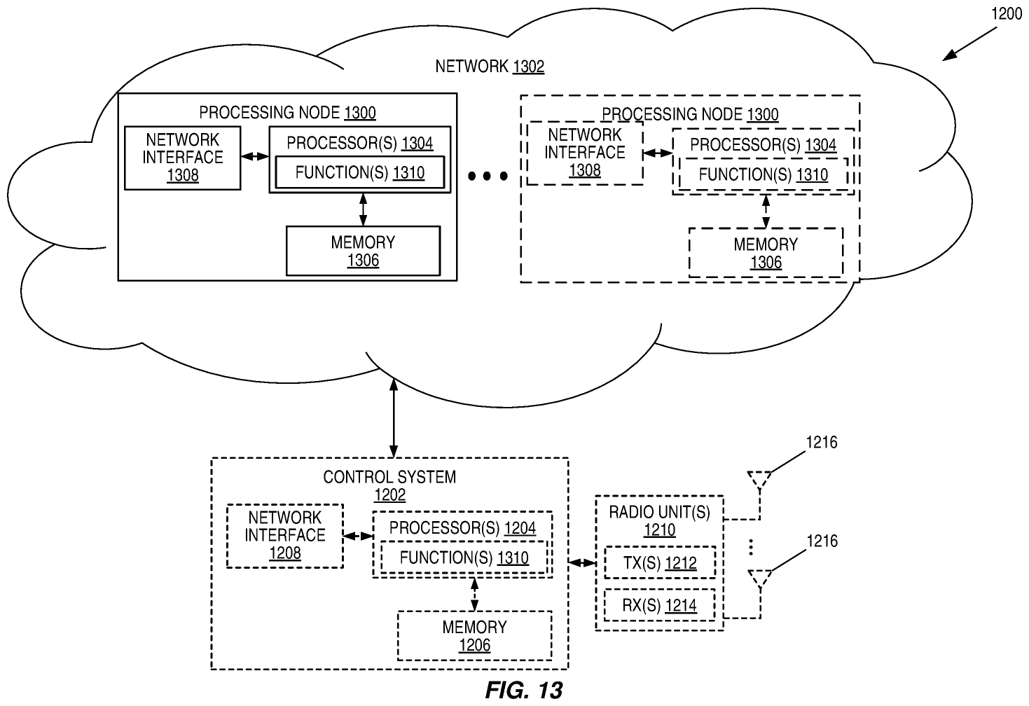

FIG. 13 is a schematic block diagram that illustrates a virtualized embodiment of the radio access node 1200 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1200 in which at least a portion of the functionality of the radio access node 1200 is implemented as a virtual component(s) (e.g., via a virtual machine(s) executing on a physical processing node(s) in a network(s)). As illustrated, in this example, the radio access node 1200 may include the control system 1202 and/or the one or more radio units 1210, as described above. The control system 1202 may be connected to the radio unit(s) 1210 via, for example, an optical cable or the like. The radio access node 1200 includes one or more processing nodes 1300 coupled to or included as part of a network(s) 1302. If present, the control system 1202 or the radio unit(s) are connected to the processing node(s) 1300 via the network 1302. Each processing node 1300 includes one or more processors 1304 (e.g., CPUs, ASICS, FPGAS, and/or the like), memory 1306, and a network interface 1308.

In this example, functions 1310 of the radio access node 1200 described herein are implemented at the one or more processing nodes 1300 or distributed across the one or more processing nodes 1300 and the control system 1202 and/or the radio unit(s) 1210 in any desired manner. In some particular embodiments, some or all of the functions 1310 of the radio access node 1200 described herein are implemented as virtual components executed by one or more virtual machines implemented in a virtual environment(s) hosted by the processing node(s) 1300. As will be appreciated by one of ordinary skill in the art, additional signaling or communication between the processing node(s) 1300 and the control system 1202 is used in order to carry out at least some of the desired functions 1310. Notably, in some embodiments, the control system 1202 may not be included, in which case the radio unit(s) 1210 communicate directly with the processing node(s) 1300 via an appropriate network interface(s).

In some embodiments, a computer program including instructions which, when executed by at least one processor, causes the at least one processor to carry out the functionality of radio access node 1200 or a node (e.g., a processing node 1300) implementing one or more of the functions 1310 of the radio access node 1200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the radio access node 1200 according to some other embodiments of the present disclosure. The radio access node 1200 includes one or more modules 1400, each of which is implemented in software. The module(s) 1400 provide the functionality of the radio access node 1200 described herein. This discussion is equally applicable to the processing node 1300 of FIG. 13 where the modules 1400 may be implemented at one of the processing nodes 1300 or distributed across multiple processing nodes 1300 and/or distributed across the processing node(s) 1300 and the control system 1202.

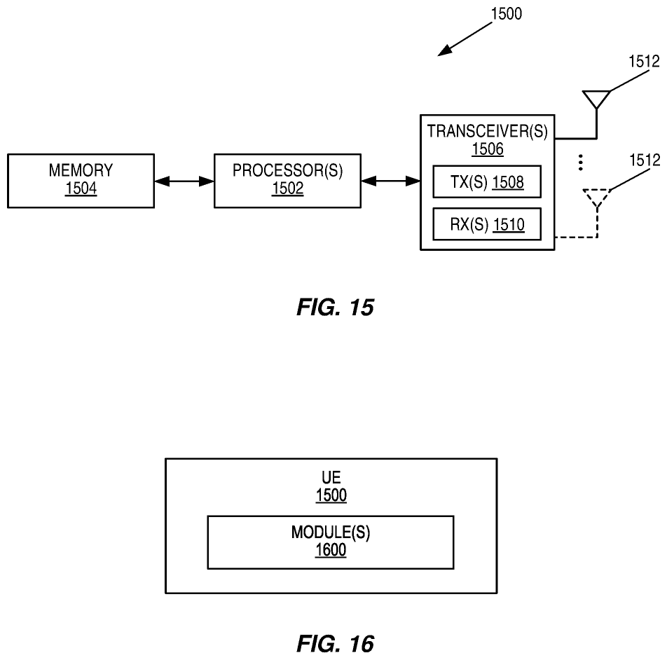

FIG. 15 is a schematic block diagram of a wireless communication device 1500 according to some embodiments of the present disclosure. As illustrated, the wireless communication device 1500 includes one or more processors 1502 (e.g., CPUs, ASICS, FPGAS, and/or the like), memory 1504, and one or more transceivers 1506 each including one or more transmitters 1508 and one or more receivers 1510 coupled to one or more antennas 1512. The transceiver(s) 1506 includes radio-front end circuitry connected to the antenna(s) 1512 that is configured to condition signals communicated between the antenna(s) 1512 and the processor(s) 1502, as will be appreciated by on of ordinary skill in the art. The processors 1502 are also referred to herein as processing circuitry. The transceivers 1506 are also referred to herein as radio circuitry. In some embodiments, the functionality of the wireless communication device 1500 described above may be fully or partially implemented in software that is, e.g., stored in the memory 1504 and executed by the processor(s) 1502. Note that the wireless communication device 1500 may include additional components not illustrated in FIG. 15 such as, e.g., one or more user interface components (e.g., an input/output interface including a display, buttons, a touch screen, a microphone, a speaker(s), and/or the like and/or any other components for allowing input of information into the wireless communication device 1500 and/or allowing output of information from the wireless communication device 1500), a power supply (e.g., a battery and associated power circuitry), etc.

In some embodiments, a computer program including instructions which, when executed by at least one processor, causes the at least one processor to carry out the functionality of the wireless communication device 1500 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the wireless communication device 1500 according to some other embodiments of the present disclosure. The wireless communication device 1500 includes one or more modules 1600, each of which is implemented in software. The module(s) 1600 provide the functionality of the wireless communication device 1500 described herein.

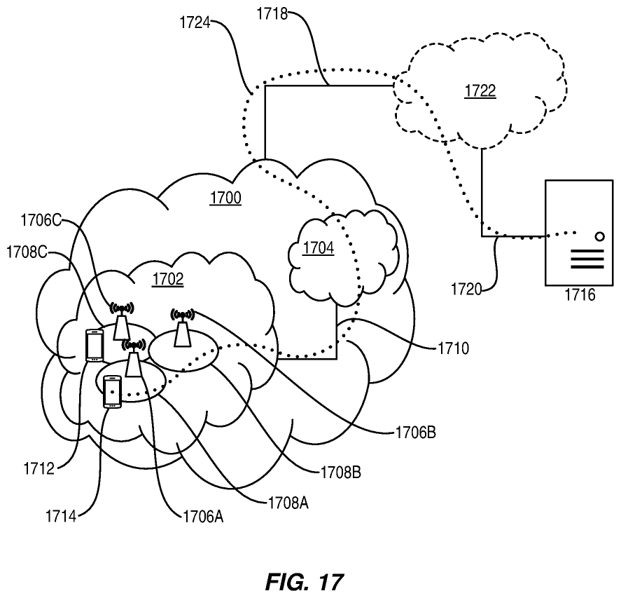

With reference to FIG. 17, in accordance with an embodiment, a communication system includes a telecommunication network 1700, such as a 3GPP-type cellular network, which comprises an access network 1702, such as a RAN, and a core network 1704. The access network 1702 comprises a plurality of base stations 1706A, 1706B, 1706C, such as Node Bs, eNBs, gNBs, or other types of wireless Access Points (APs), each defining a corresponding coverage area 1708A, 1708B, 1708C. Each base station 1706A, 1706B, 1706C is connectable to the core network 1704 over a wired or wireless connection 1710. A first UE 1712 located in coverage area 1708C is configured to wirelessly connect to, or be paged by, the corresponding base station 1706C. A second UE 1714 in coverage area 1708A is wirelessly connectable to the corresponding base station 1706A. While a plurality of UEs 1712, 1714 are illustrated in this example, the disclosed embodiments are equally applicable to a situation where a sole UE is in the coverage area or where a sole UE is connecting to the corresponding base station 1706.

The telecommunication network 1700 is itself connected to a host computer 1716, which may be embodied in the hardware and/or software of a standalone server, a cloud-implemented server, a distributed server, or as processing resources in a server farm. The host computer 1716 may be under the ownership or control of a service provider, or may be operated by the service provider or on behalf of the service provider. Connections 1718 and 1720 between the telecommunication network 1700 and the host computer 1716 may extend directly from the core network 1704 to the host computer 1716 or may go via an optional intermediate network 1722. The intermediate network 1722 may be one of, or a combination of more than one of, a public, private, or hosted network; the intermediate network 1722, if any, may be a backbone network or the Internet; in particular, the intermediate network 1722 may comprise two or more sub-networks (not shown).

The communication system of FIG. 17 as a whole enables connectivity between the connected UEs 1712, 1714 and the host computer 1716. The connectivity may be described as an Over-the-Top (OTT) connection 1724. The host computer 1716 and the connected UEs 1712, 1714 are configured to communicate data and/or signaling via the OTT connection 1724, using the access network 1702, the core network 1704, any intermediate network 1722, and possible further infrastructure (not shown) as intermediaries. The OTT connection 1724 may be transparent in the sense that the participating communication devices through which the OTT connection 1724 passes are unaware of routing of uplink and downlink communications. For example, the base station 1706 may not or need not be informed about the past routing of an incoming downlink communication with data originating from the host computer 1716 to be forwarded (e.g., handed over) to a connected UE 1712. Similarly, the base station 1706 need not be aware of the future routing of an outgoing uplink communication originating from the UE 1712 towards the host computer 1716.

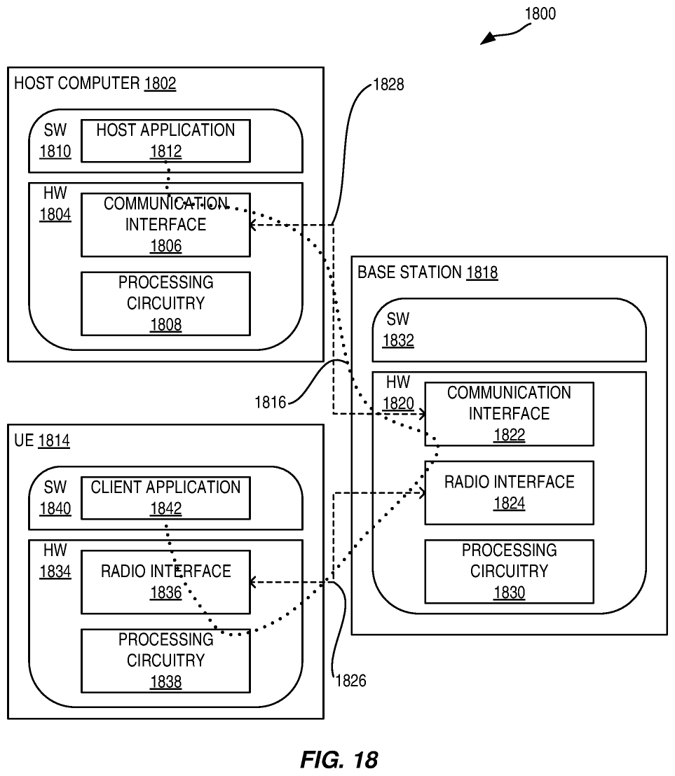

Example implementations, in accordance with an embodiment, of the UE, base station, and host computer discussed in the preceding paragraphs will now be described with reference to FIG. 18. In a communication system 1800, a host computer 1802 comprises hardware 1804 including a communication interface 1806 configured to set up and maintain a wired or wireless connection with an interface of a different communication device of the communication system 1800. The host computer 1802 further comprises processing circuitry 1808, which may have storage and/or processing capabilities. In particular, the processing circuitry 1808 may comprise one or more programmable processors, ASICS, FPGAS, or combinations of these (not shown) adapted to execute instructions. The host computer 1802 further comprises software 1810, which is stored in or accessible by the host computer 1802 and executable by the processing circuitry 1808. The software 1810 includes a host application 1812. The host application 1812 may be operable to provide a service to a remote user, such as a UE 1814 connecting via an OTT connection 1816 terminating at the UE 1814 and the host computer 1802. In providing the service to the remote user, the host application 1812 may provide user data which is transmitted using the OTT connection 1816.

The communication system 1800 further includes a base station 1818 provided in a telecommunication system and comprising hardware 1820 enabling it to communicate with the host computer 1802 and with the UE 1814. The hardware 1820 may include a communication interface 1822 for setting up and maintaining a wired or wireless connection with an interface of a different communication device of the communication system 1800, as well as a radio interface 1824 for setting up and maintaining at least a wireless connection 1826 with the UE 1814 located in a coverage area (not shown in FIG. 18) served by the base station 1818. The communication interface 1822 may be configured to facilitate a connection 1828 to the host computer 1802. The connection 1828 may be direct or it may pass through a core network (not shown in FIG. 18) of the telecommunication system and/or through one or more intermediate networks outside the telecommunication system. In the embodiment shown, the hardware 1820 of the base station 1818 further includes processing circuitry 1830, which may comprise one or more programmable processors, ASICs, FPGAS, or combinations of these (not shown) adapted to execute instructions. The base station 1818 further has software 1832 stored internally or accessible via an external connection.

The communication system 1800 further includes the UE 1814 already referred to. The UE's 1814 hardware 1834 may include a radio interface 1836 configured to set up and maintain a wireless connection 1826 with a base station serving a coverage area in which the UE 1814 is currently located. The hardware 1834 of the UE 1814 further includes processing circuitry 1838, which may comprise one or more programmable processors, ASICs, FPGAS, or combinations of these (not shown) adapted to execute instructions. The UE 1814 further comprises software 1840, which is stored in or accessible by the UE 1814 and executable by the processing circuitry 1838. The software 1840 includes a client application 1842. The client application 1842 may be operable to provide a service to a human or non-human user via the UE 1814, with the support of the host computer 1802. In the host computer 1802, the executing host application 1812 may communicate with the executing client application 1842 via the OTT connection 1816 terminating at the UE 1814 and the host computer 1802. In providing the service to the user, the client application 1842 may receive request data from the host application 1812 and provide user data in response to the request data. The OTT connection 1816 may transfer both the request data and the user data. The client application 1842 may interact with the user to generate the user data that it provides.

It is noted that the host computer 1802, the base station 1818, and the UE 1814 illustrated in FIG. 18 may be similar or identical to the host computer 1716, one of the base stations 1706A, 1706B, 1706C, and one of the UEs 1712, 1714 of FIG. 17, respectively. This is to say, the inner workings of these entities may be as shown in FIG. 18 and independently, the surrounding network topology may be that of FIG. 17.

In FIG. 18, the OTT connection 1816 has been drawn abstractly to illustrate the communication between the host computer 1802 and the UE 1814 via the base station 1818 without explicit reference to any intermediary devices and the precise routing of messages via these devices. The network infrastructure may determine the routing, which may be configured to hide from the UE 1814 or from the service provider operating the host computer 1802, or both. While the OTT connection 1816 is active, the network infrastructure may further take decisions by which it dynamically changes the routing (e.g., on the basis of load balancing consideration or reconfiguration of the network).

The wireless connection 1826 between the UE 1814 and the base station 1818 is in accordance with the teachings of the embodiments described throughout this disclosure. One or more of the various embodiments improve the performance of OTT services provided to the UE 1814 using the OTT connection 1816, in which the wireless connection 1826 forms the last segment. More precisely, the teachings of these embodiments may improve the e.g., data rate, latency, power consumption, etc. and thereby provide benefits such a e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1816 between the host computer 1802 and the UE 1814, in response to variations in the measurement results. The measurement procedure and/or the network functionality for reconfiguring the OTT connection 1816 may be implemented in the software 1810 and the hardware 1804 of the host computer 1802 or in the software 1840 and the hardware 1834 of the UE 1814, or both. In some embodiments, sensors (not shown) may be deployed in or in association with communication devices through which the OTT connection 1816 passes; the sensors may participate in the measurement procedure by supplying values of the monitored quantities exemplified above, or supplying values of other physical quantities from which the software 1810, 1840 may compute or estimate the monitored quantities. The reconfiguring of the OTT connection 1816 may include message format, retransmission settings, preferred routing, etc.; the reconfiguring need not affect the base station 1818, and it may be unknown or imperceptible to the base station 1818. Such procedures and functionalities may be known and practiced in the art. In certain embodiments, measurements may involve proprietary UE signaling facilitating the host computer 1802's measurements of throughput, propagation times, latency, and the like. The measurements may be implemented in that the software 1810 and 1840 causes messages to be transmitted, in particular empty or ‘dummy’ messages, using the OTT connection 1816 while it monitors propagation times, errors, etc.

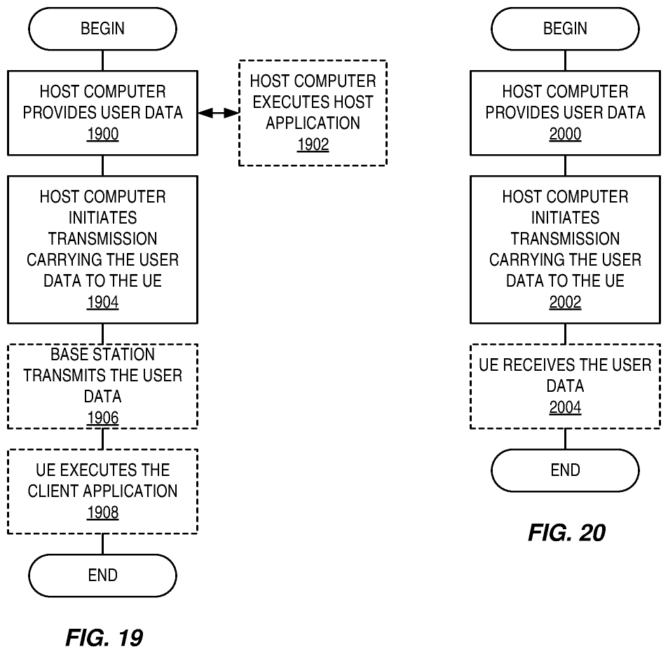

FIG. 19 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 19 will be included in this section. In step 1900, the host computer provides user data. In sub-step 1902 (which may be optional) of step 1900, the host computer provides the user data by executing a host application. In step 1904, the host computer initiates a transmission carrying the user data to the UE. In step 1906 (which may be optional), the base station transmits to the UE the user data which was carried in the transmission that the host computer initiated, in accordance with the teachings of the embodiments described throughout this disclosure. In step 1908 (which may also be optional), the UE executes a client application associated with the host application executed by the host computer.

FIG. 20 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 20 will be included in this section. In step 2000 of the method, the host computer provides user data. In an optional sub-step (not shown) the host computer provides the user data by executing a host application. In step 2002, the host computer initiates a transmission carrying the user data to the UE. The transmission may pass via the base station, in accordance with the teachings of the embodiments described throughout this disclosure. In step 2004 (which may be optional), the UE receives the user data carried in the transmission.

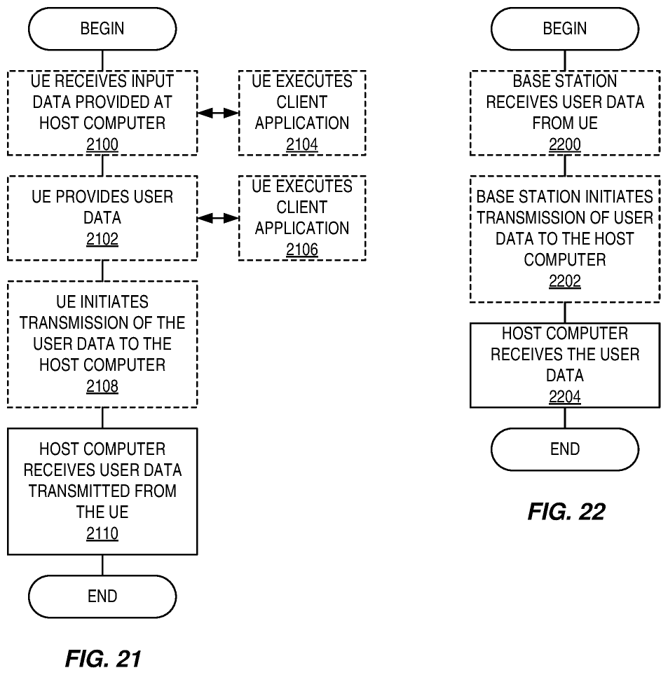

FIG. 21 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 21 will be included in this section. In step 2100 (which may be optional), the UE receives input data provided by the host computer. Additionally or alternatively, in step 2102, the UE provides user data. In sub-step 2104 (which may be optional) of step 2100, the UE provides the user data by executing a client application. In sub-step 2106 (which may be optional) of step 2102, the UE executes a client application which provides the user data in reaction to the received input data provided by the host computer. In providing the user data, the executed client application may further consider user input received from the user. Regardless of the specific manner in which the user data was provided, the UE initiates, in sub-step 2108 (which may be optional), transmission of the user data to the host computer. In step 2110 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 22 will be included in this section. In step 2200 (which may be optional), in accordance with the teachings of the embodiments described throughout this disclosure, the base station receives user data from the UE. In step 2202 (which may be optional), the base station initiates transmission of the received user data to the host computer. In step 2204 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

### Group A Embodiments

Embodiment 1: A method performed by a wireless device for channel state information, CSI, reporting, the method comprising one or more of: receiving a configuration for a plurality of NZP CSI-RS resources from a base station; performing channel measurement on the plurality of NZP CSI-RS resources; selecting N of the plurality of NZP CSI-RS resources; performing CSI computations and/or calculating CSI parameters including one rank indicator, RI, N precoding matrix indicator, PMI, and one channel quality indicator, CQI; and reporting the calculated CSI parameters including one or more of: one RI, N PMIs, one CQI along with one or more of the following as part of CSI reporting: i. a single CSI-RS resource indicator, CRI, indicating the selected N NZP CSI-RS resources; ii. N CRIs indicating the selected N NZP CSI-RS resources; and iii. no CRI.

Embodiment 2: The method of embodiment 1 where the plurality of NZP CSI-RS resources are configured as part of N NZP CSI-RS resource sets.

Embodiment 3: The method of embodiment 2, where a single CRI is used to selected one NZP CSI-RS resource from each of the N NZP CSI-RS resource sets.

Embodiment 4: The method of any of embodiments 1-2, wherein the plurality of NZP CSI-RS resources are configured as part of a single NZP CSI-RS resource set.

Embodiment 5: The method of any of embodiments 1-4, wherein N CRIs are used to select N NZP CSI-RS resources from the single NZP CSI-RS resource set.

Embodiment 6: The method of any of embodiments 1-5, wherein the CSI parameters of one RI, N PMIs, one CQI along with one, N or no CRIs to be reported are configured by setting the reportQuantity field in CSI-ReportConfig information element to one of the following values: cri-RI-NPMI-CQI; Ncri-RI-NPMI-CQI; and RI-NPMI-CQI.

Embodiment 7: The method of any of embodiments 1-6, wherein the wireless device takes into account one of a plurality of PDSCH transmission schemes for which CSI is computed.

Embodiment 8: The method of any of embodiments 1-7, wherein the PDSCH transmission scheme can be any one of: FDMSchemeA, FDMSchemeB, TDMSchemeA, and SlotBasedTDM.

Embodiment 9: The method of any of embodiments 1-8, wherein the PDSCH transmission scheme for which to compute CSI is configures as part of the CSI-ReportConfig information element via a higher layer parameter reportingScheme.

Embodiment 10: The method of any of embodiments 1-9, wherein the wireless device assumes two repetitions when computing CSI when the PDSCH transmission scheme for which to compute CSI is either FDMSchemeB or TDMSchemeA.

Embodiment 11: The method of any of embodiments 1-10, wherein the wireless device assumes a single PDSCH transmission when computing CSI when the PDSCH transmission scheme for which to compute CSI is FDMSchemeA.

Embodiment 12: The method of any of embodiments 1-11, wherein the wireless device assumes P repetitions when computing CSI when the PDSCH transmission scheme for which to compute CSI is SlotBasedTDM, wherein P>1 is configured as part of CSI-ReportConfig.

Embodiment 13: The method of any of embodiments 1-12, wherein the CSI reference resource is defined by P consecutive slots with the last slot in downlink slot n-n_(CSI-ref) in time domain wherein the slot n_(CSI-ref) is predefined in specifications.

Embodiment 14: The method of any of embodiments 1-13, wherein the wireless device assumes a number of PDSCH symbols per repetition when computing CSI when the PDSCH transmission scheme for which to compute CSI is TDMSchemeA, wherein the number of PDSCH symbols per repetition is either predefined in specifications or is configured as part of CSI-ReportConfig.

Embodiment 15: The method of any of embodiments 1-14, wherein the PRB bundling granularity to be assumed for CSI calculation by the wireless device is provided as part of CSI-ReportConfig or predefined in specifications when the PDSCH transmission scheme for which to compute CSI is either FDMSchemeA or FDMSchemeB.

Embodiment 16: The method of any of the previous embodiments, further comprising: providing user data; and forwarding the user data to a host computer via the transmission to the base station.

### Group B Embodiments

Embodiment 17: A method performed by a base station for enabling channel state information, CSI, reporting, the method comprising one or more of: transmitting, to a wireless device, a configuration for a plurality of NZP CSI-RS resources; receiving, from the wireless device, calculated CSI parameters including one or more of: one RI, N PMIs, one CQI along with one or more of the following as part of CSI reporting: i. a single CSI-RS resource indicator, CRI, indicating the selected N NZP CSI-RS resources; ii. N CRIs indicating the selected N NZP CSI-RS resources; and iii. no CRI.

Embodiment 18: The method of embodiment 17, wherein the wireless device performed one or more of: performing channel measurement on the plurality of NZP CSI-RS resources; selecting N of the plurality of NZP CSI-RS resources; and performing CSI computations and/or calculating CSI parameters including one rank indicator, RI, N precoding matrix indicator, PMI, and one channel quality indicator, CQI.

Embodiment 19: The method of any of embodiments 17-18 where the plurality of NZP CSI-RS resources are configured as part of N NZP CSI-RS resource sets.

Embodiment 20: The method of embodiment 19, where a single CRI is used to selected one NZP CSI-RS resource from each of the N NZP CSI-RS resource sets.

Embodiment 21: The method of any of embodiments 17-20, wherein the plurality of NZP CSI-RS resources are configured as part of a single NZP CSI-RS resource set.

Embodiment 22: The method of any of embodiments 17-21, wherein N CRIs are used to select N NZP CSI-RS resources from the single NZP CSI-RS resource set.

Embodiment 23: The method of any of embodiments 17-22, wherein the CSI parameters of one RI, N PMIs, one CQI along with one, N or no CRIs to be reported are configured by setting the reportQuantity field in CSI-ReportConfig information element to one of the following values: cri-RI-NPMI-CQI; Ncri-RI-NPMI-CQI; and RI-NPMI-CQI.

Embodiment 24: The method of any of embodiments 17-23, wherein the wireless device takes into account one of a plurality of PDSCH transmission schemes for which CSI is computed.

Embodiment 25: The method of any of embodiments 17-24, wherein the PDSCH transmission scheme can be any one of: FDMSchemeA, FDMSchemeB, TDMSchemeA, and SlotBasedTDM.

Embodiment 26: The method of any of embodiments 17-25, wherein the PDSCH transmission scheme for which to compute CSI is configures as part of the CSI-ReportConfig information element via a higher layer parameter reportingScheme.

Embodiment 27: The method of any of embodiments 17-26, wherein the wireless device assumes two repetitions when computing CSI when the PDSCH transmission scheme for which to compute CSI is either FDMSchemeB or TDMSchemeA.

Embodiment 28: The method of any of embodiments 17-27, wherein the wireless device assumes a single PDSCH transmission when computing CSI when the PDSCH transmission scheme for which to compute CSI is FDMSchemeA.

Embodiment 29: The method of any of embodiments 17-28, wherein the wireless device assumes P repetitions when computing CSI when the PDSCH transmission scheme for which to compute CSI is SlotBasedTDM, wherein P>1 is configured as part of CSI-ReportConfig.

Embodiment 30: The method of any of embodiments 1-29, wherein the CSI reference resource is defined by P consecutive slots with the last slot in downlink slot n-n_(CSI-ref) in time domain wherein the slot n_(CSI-ref) is predefined in specifications.

Embodiment 31: The method of any of embodiments 17-30, wherein the wireless device assumes a number of PDSCH symbols per repetition when computing

CSI when the PDSCH transmission scheme for which to compute CSI is TDMSchemeA, wherein the number of PDSCH symbols per repetition is either predefined in specifications or is configured as part of CSI-ReportConfig.

Embodiment 32: The method of any of embodiments 17-14, wherein the PRB bundling granularity to be assumed for CSI calculation by the wireless device is provided as part of CSI-ReportConfig or predefined in specifications when the PDSCH transmission scheme for which to compute CSI is either FDMSchemeA or FDMSchemeB.

Embodiment 33: The method of any of the previous embodiments, further comprising: obtaining user data; and forwarding the user data to a host computer or a wireless device.

### Group C Embodiments

Embodiment 34: A wireless device for channel state information, CSI, reporting, the wireless device comprising: processing circuitry configured to perform any of the steps of any of the Group A embodiments; and power supply circuitry configured to supply power to the wireless device.

Embodiment 35: A base station for enabling channel state information, CSI, reporting, the base station comprising: processing circuitry configured to perform any of the steps of any of the Group B embodiments; and power supply circuitry configured to supply power to the base station.

Embodiment 36: A User Equipment, UE, for channel state information, CSI, reporting, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 37: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 38: The communication system of the previous embodiment further including the base station.

Embodiment 39: The communication system of the previous 2 embodiments, further including the UE, wherein the UE is configured to communicate with the base station.

Embodiment 40: The communication system of the previous 3 embodiments, wherein: the processing circuitry of the host computer is configured to execute a host application, thereby providing the user data; and the UE comprises processing circuitry configured to execute a client application associated with the host application.

Embodiment 41: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 42: The method of the previous embodiment, further comprising, at the base station, transmitting the user data.

Embodiment 43: The method of the previous 2 embodiments, wherein the user data is provided at the host computer by executing a host application, the method further comprising, at the UE, executing a client application associated with the host application.

Embodiment 44: A User Equipment, UE, configured to communicate with a base station, the UE comprising a radio interface and processing circuitry configured to perform the method of the previous 3 embodiments.

Embodiment 45: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 46: The communication system of the previous embodiment, wherein the cellular network further includes a base station configured to communicate with the UE.

Embodiment 47: The communication system of the previous 2 embodiments, wherein: the processing circuitry of the host computer is configured to execute a host application, thereby providing the user data; and the UE's processing circuitry is configured to execute a client application associated with the host application.

Embodiment 48: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 49: The method of the previous embodiment, further comprising at the UE, receiving the user data from the base station.

Embodiment 50: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 51: The communication system of the previous embodiment, further including the UE.

Embodiment 52: The communication system of the previous 2 embodiments, further including the base station, wherein the base station comprises a radio interface configured to communicate with the UE and a communication interface configured to forward to the host computer the user data carried by a transmission from the UE to the base station.

Embodiment 53: The communication system of the previous 3 embodiments, wherein: the processing circuitry of the host computer is configured to execute a host application; and the UE's processing circuitry is configured to execute a client application associated with the host application, thereby providing the user data.

Embodiment 54: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 55: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 56: The method of the previous embodiment, further comprising, at the UE, providing the user data to the base station.

Embodiment 57: The method of the previous 2 embodiments, further comprising: at the UE, executing a client application, thereby providing the user data to be transmitted; and at the host computer, executing a host application associated with the client application.

Embodiment 58: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 59: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 60: The communication system of the previous embodiment further including the base station.

Embodiment 61: The communication system of the previous 2 embodiments, further including the UE, wherein the UE is configured to communicate with the base station.

Embodiment 62: The communication system of the previous 3 embodiments, wherein: the processing circuitry of the host computer is configured to execute a host application; and the UE is configured to execute a client application associated with the host application, thereby providing the user data to be received by the host computer.

Embodiment 63: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 64: The method of the previous embodiment, further comprising at the base station, receiving the user data from the UE.

Embodiment 65: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AMF Access and Mobility Management Function
AN Access Network
AP Access Point
ASIC Application Specific Integrated Circuit
AUSF Authentication Server Function
BLER Block Error Rate
BWP Bandwidth Part
CQI Channel Quality Indicator
CRI Channel Resource Indicator
CSI Channel State Information
CSI-IM Channel State Information Interference Measurement
CSI-RS Channel State Information Reference Signal
CP-OFDM Cyclic Prefix Orthogonal Frequency Division Multiplexing
CPU Central Processing Unit
DCI Downlink Control Information
DFT Discrete Fourier Transform
DL Downlink
DMRS Demodulation Reference Signal
DN Data Network
DSP Digital Signal Processor
eNB Enhanced or Evolved Node B
FDM Frequency Domain Multiplexing
FDRA Frequency Domain Resource Assignment
FPGA Field Programmable Gate Array
gNB New Radio Base Station
gNB-CU New Radio Base Station Central Unit
gNB-DU New Radio Base Station Distributed Unit
HARQ Hybrid Automatic Repeat Request
HSS Home Subscriber Server
IOT Internet of Things
LTE Long Term Evolution
MCS Modulation and Coding Scheme
MIMO Multiple-Input-Multiple-Output
MME Mobility Management Entity
MTC Machine Type Communication
NCJT Non-coherent Joint Transmission
NDI New Data Indicator
NEF Network Exposure Function
NF Network Function
NG-RAN Next Generation Radio Access Network
NR New Radio
NRF Network Function Repository Function
NSSF Network Slice Selection Function
NZP Non-Zero Power
OFDM Orthogonal Frequency Division Multiplexing
OTT Over-the-Top
PC Personal Computer
PCF Policy Control Function
PDCCH Physical Downlink Control Channel
PDSCH Physical Downlink Shared Channel
P-GW Packet Data Network Gateway
PMI Precoding Matrix Indicator
PRB Physical Resource Block
PRG Precoding Resource Block Group
PUSCH Physical Uplink Shared Channel
QCL Quasi Co-Located
RAM Random Access Memory
RAN Radio Access Network
RB Resource Blocks
RE Resource Element
RI Rank Indicator
ROM Read Only Memory
RRC Radio Resource Control
RRH Remote Radio Head
RS Reference Signal
RV Redundancy Version
SCEF Service Capability Exposure Function
SINR Signal to Interference plus Noise Ratio
SMF Session Management Function
TB Transport Block
TCI Transmission Configuration Indicator
TDM Time Domain Multiplexing
TDRA Time Domain Resource Assignment
TRP Transmission/Reception Point
UDM Unified Data Management
UE User Equipment
UPF User Plane Function
URLLC Ultra-Reliable and Low Latency Communication

Those skilled in the art will recognize improvements and modifications to the embodiments of the present disclosure. All such improvements and modifications are considered within the scope of the concepts disclosed herein.

1. A method performed by a wireless device for Channel State Information, CSI, reporting, the method comprising:
receiving a configuration for a plurality of Non-Zero Power, NZP, CSI Reference Signal, CSI-RS, resources from a base station;
performing channel measurement on the plurality of NZP CSI-RS resources;
selecting N of the plurality of NZP CSI-RS resources;
performing CSI computations and/or calculating CSI parameters including one or more of: one Rank Indicator, RI, N Precoding Matrix Indicators, PMIs, and one Channel Quality Indicator, CQI; and
reporting the calculated CSI parameters including one or more of: one RI, N PMIs, one CQI along with one or more of the following as part of CSI reporting:
a single CSI-RS Resource Indicator, CRI, indicating the selected N NZP CSI-RS resources;
N CRIs indicating the selected N NZP CSI-RS resources; and
no CRI.

2. The method of claim 1 where the plurality of NZP CSI-RS resources are configured as part of N NZP CSI-RS resource sets.

3. The method of claim 2, where a single CRI is used to selected one NZP CSI-RS resource from each of the N NZP CSI-RS resource sets.

4. The method of claim 1, wherein the plurality of NZP CSI-RS resources are configured as part of a single NZP CSI-RS resource set.

5. The method of claim 4, wherein N CRIs are used to select N NZP CSI-RS resources from the single NZP CSI-RS resource set.

6. The method of claim 1, wherein the CSI parameters of one RI, N PMIs, one CQI along with one, N or no CRIs to be reported are configured by setting a reportQuantity field in CSI-ReportConfig information element to one of the following values: cri-RI-NPMI-CQI; Ncri-RI-NPMI-CQI; and RI-NPMI-CQI.

7. The method of claim 1, further comprising: taking into account one of a plurality of Physical Downlink Shared Channel, PDSCH, transmission schemes for which CSI is computed.

8. The method of claim 1, wherein the PDSCH transmission scheme comprises one of: FDMSchemeA, FDMSchemeB, TDMSchemeA, and SlotBasedTDM.

9. The method of claim 1, wherein the PDSCH transmission scheme for which to compute CSI is configured as part of the CSI-ReportConfig information element via a higher layer parameter reportingScheme.

10. The method of claim 1, further comprising: assuming two PDSCH transmission occasions when computing CSI when the PDSCH transmission scheme for which to compute CSI is either FDMSchemeB or TDMSchemeA.

11. The method of claim 1, further comprising: assuming a single PDSCH transmission occasion when computing CSI when the PDSCH transmission scheme for which to compute CSI is FDMSchemeA.

12. The method of claim 1, further comprising: assuming P>1 PDSCH transmission occasions when computing CSI when the PDSCH transmission scheme for which to compute CSI is SlotBasedTDM.

13. The method of claim 1, wherein the CSI reference resource is defined by P consecutive slots with the last slot in downlink slot n−n_(CSI-ref) in time domain wherein the slot n_(CSI-ref) is predefined in specifications.

14. The method of claim 1, wherein the wireless device assumes a number of PDSCH symbols per PDSCH transmission occasion when computing CSI when the PDSCH transmission scheme for which to compute CSI is TDMSchemeA, wherein the number of PDSCH symbols per PDSCH transmission occasion is either predefined in specifications or is configured as part of CSI-ReportConfig.

15. The method of claim 1, wherein a Physical Resource Block, PRB, bundling granularity to be assumed for CSI calculation by the wireless device is provided as part of CSI-ReportConfig or predefined in specifications when the PDSCH transmission scheme for which to compute CSI is either FDMSchemeA or FDMSchemeB.

16. The method of claim 1, wherein the wireless device operates in a New Radio, NR, network.

17. A method performed by a base station for enabling Channel State Information, CSI, reporting, the method comprising:
transmitting, to a wireless device, a configuration for a plurality of Non-Zero Power, NZP, CSI Reference Signal, CSI-RS, resources; and
receiving, from the wireless device, calculated CSI parameters including one or more of: one Rank Indicator, RI, N Precoding Matrix Indicators, PMIs, one Channel Quality Indicator, CQI, along with one or more of the following as part of CSI reporting:
a single CSI-RS Resource Indicator, CRI, indicating the selected N NZP CSI-RS resources;
N CRIs indicating the selected N NZP CSI-RS resources; and
no CRI.

18. The method of claim 17, wherein the wireless device performed one or more of:
performing channel measurement on the plurality of NZP CSI-RS resources;
selecting N of the plurality of NZP CSI-RS resources; and
performing CSI computations and/or calculating CSI parameters including one RI N PMI, and one CQI.

19-32. (canceled)

33. A wireless device to support Physical Uplink Shared Channel, PUSCH, multiple Transmission/Reception Point, multi-TRP, transmission comprising:
one or more transmitters;
one or more receivers; and
processing circuitry associated with the one or more transmitters and the one or more receivers, the processing circuitry configured to cause the wireless device to:
receive a configuration for a plurality of Non-Zero Power, NZP, Channel State Information Reference Signal, CSI-RS, resources from a base station;
perform channel measurement on the plurality of NZP CSI-RS resources;
select N of the plurality of NZP CSI-RS resources;
perform Channel State Information, CSI computations and/or calculating CSI parameters including one or more of: one Rank Indicator, RI, N Precoding Matrix Indicators, PMIs, and one Channel Quality Indicator, CQI; and
report the calculated CSI parameters including one or more of: one RI, N PMIs, one CQI along with one or more of the following as part of CSI reporting:
a single CSI-RS Resource Indicator, CRI, indicating the selected N NZP CSI-RS resources;
N CRIs indicating the selected N NZP CSI-RS resources; and
no CRI.

34. (canceled)

35. A base station to support Physical Uplink Shared Channel, PUSCH, multiple Transmission/Reception Point, multi-TRP, transmission, comprising:
one or more transmitters;
one or more receivers; and
processing circuitry associated with the one or more transmitters and the one or more receivers, the processing circuitry configured to cause the base station to perform one or more of:
transmit, to a wireless device, a configuration for a plurality of Non-Zero Power, NZP, Channel State Information Reference Signal, CSI-RS, resources; and
receive, from the wireless device, calculated Channel State Information, CSI, parameters including one or more of: one Rank Indicator, RI, N Precoding Matrix Indicators, PMIs, one Channel Quality Indicator, CQI, along with one or more of the following as part of CSI reporting:
a single CSI-RS Resource Indicator, CRI, indicating the selected N NZP CSI-RS resources;
N CRIs indicating the selected N NZP CSI-RS resources; and
no CRI.

36. (canceled)
